(19) United States
(12) Patent Application Publication
(10) Pub. No.: US 2025/0087085 A1
(43) Pub. Date: Mar. 13, 2025

(54) APPARATUS AND METHOD FOR DETECTING DANGEROUS DRIVING OR CUTTING-IN VEHICLE

(71) Applicant: SK Planet Co., Ltd., Seongnam-si (KR)

(72) Inventors: Yeong Hyeon PARK, Suwon-si (KR); Myung Jin KIM, Seongnam-si (KR)

(21) Appl. No.: 18/829,995

(22) Filed: Sep. 10, 2024

(30) Foreign Application Priority Data
Sep. 12, 2023 (KR) 10-2023-0121300
Sep. 12, 2023 (KR) 10-2023-0121301
Oct. 18, 2023 (KR) 10-2023-0139931
Nov. 29, 2023 (KR) 10-2023-0170202

(51) Int. Cl. G08G 1/017; G06V 10/26; G06V 10/75; G06V 20/17; G06V 20/52; G06V 20/58; G08G 1/01; G08G 1/054

(52) U.S. Cl. CPC G08G 1/0175; G06V 10/26; G06V 10/751; G06V 20/17; G06V 20/52; G06V 20/58; G08G 1/0112; G08G 1/0141; G08G 1/054; G06V 2201/08

(57) ABSTRACT

An apparatus and method for detecting a dangerous (or reckless) driving vehicle using a movable photographing device (e.g., a camera-equipped drone, a camera-equipped car, etc.) or fixed-type photographing device (e.g., CCTV), which is capable of capturing images, are provided. In addition, an apparatus and method for detecting a cutting-in vehicle by analyzing captured images of vehicles are provided.

### CROSS-REFERENCE TO RELATED APPLICATIONS

This application claims the benefit of priority to Korean Patent Application Nos. 10-2023-0121300, filed on Sep. 12, 2023, 10-2023-0121301, filed on Sep. 12, 2023, 10-2023-0139931, filed on Oct. 18, 2023, and 10-2023-0170202, filed on Nov. 29, 2023. The disclosures of the above-listed applications are herein incorporated by reference herein in their entirety.

### TECHNICAL FIELD

The present disclosure relates to an apparatus and method for detecting a dangerous driving vehicle or a cutting-in vehicle based on image analysis.

### BACKGROUND ART

Various recognition technologies are being developed to detect illegal acts such as speeding on roads where vehicles are driving. For example, technologies for cracking down on speeding are well known.

In addition, there are various driving behaviors on the road that can cause traffic congestion or traffic accidents, such as dangerous (or reckless) driving or cutting in. Accordingly, technologies for detecting dangerous driving vehicles or cutting-in vehicles are also needed.

### SUMMARY

The present disclosure provides an apparatus and method for detecting a dangerous (or reckless) driving vehicle using a movable photographing device (e.g., a camera-equipped drone, a camera-equipped car, etc.) or fixed-type photographing device (e.g., CCTV), which is capable of capturing images.

In addition, the present disclosure provides an apparatus and method for detecting a cutting-in vehicle by analyzing captured images of vehicles.

According to an embodiment of the present disclosure, an apparatus for detecting a dangerous driving vehicle may include a server communication circuit and a server processor functionally connected to the server communication circuit. The server processor may be configured to provide coordinate information for a specific area of a road to a movable photographing device, to receive a photographed image for the specific area of the road corresponding to the coordinate information from the movable photographing device, to detect at least one vehicle object from the photographed image, to detect driving information of the detected at least one vehicle object, to check whether the driving information satisfies a predefined dangerous driving condition, and if the dangerous driving condition is satisfied, to determine a vehicle corresponding to the driving information as a dangerous driving vehicle.

The server processor may be configured to identify a location of the specific area of the road, to determine a type of movable photographing device based on the identified location, and to provide the coordinate information to the determined type of movable photographing device.

The server processor may be configured to collect vehicle information on the dangerous driving vehicle, and to provide the vehicle information and a warning message about the dangerous driving vehicle to the movable photographing device so that the movable photographing device outputs the warning message toward the dangerous driving vehicle through an audio device of the movable photographing device.

The server processor may be configured to detect driving information of the at least one vehicle object, to obtain the driving information of the at least one vehicle object again after a given time, and to compare the obtained driving information with the detected driving information so as to determine the vehicle with the driving information as the dangerous driving vehicle when dangerous driving continues for the given time.

The server processor may be configured to track a vehicle-to-vehicle distance, and if the vehicle-to-vehicle distance is within a predefined range or is gradually reduced and then maintained for a predefined period of time or longer, to determine at least one vehicle object in a vehicle object pair corresponding to the vehicle-to-vehicle distance as the dangerous driving vehicle.

The server processor may be configured to, when a plurality of vehicle objects satisfying the dangerous driving condition are detected, determine, as the dangerous driving vehicle, a vehicle object having a greater speed change, a vehicle object having a speed change greater than a predefined reference value, or a vehicle object having a lane change greater than a predefined number of times within a predefined period of time.

According to an embodiment of the present disclosure, a method for detecting a dangerous driving vehicle is performed by a server processor of a dangerous driving vehicle detection apparatus. The method may include providing coordinate information for a specific area of a road to a movable photographing device; receiving a photographed image for the specific area of the road corresponding to the coordinate information from the movable photographing device; detecting at least one vehicle object from the photographed image; detecting driving information of the detected at least one vehicle object; checking whether the driving information satisfies a predefined dangerous driving condition; and if the dangerous driving condition is satisfied, determining a vehicle corresponding to the driving information as a dangerous driving vehicle.

The method may further include identifying a location of the specific area of the road; determining a type of movable photographing device based on the identified location; and providing the coordinate information to the determined type of movable photographing device.

The method may further include collecting vehicle information on the dangerous driving vehicle; and providing the vehicle information and a warning message about the dangerous driving vehicle to the movable photographing device so that the movable photographing device outputs the warning message toward the dangerous driving vehicle through an audio device of the movable photographing device.

In the method, determining a vehicle as a dangerous driving vehicle may include detecting driving information of the at least one vehicle object; obtaining the driving information of the at least one vehicle object again after a given time; and comparing the obtained driving information with the detected driving information so as to determine the vehicle with the driving information as the dangerous driving vehicle when dangerous driving continues for the given time.

In the method, determining a vehicle as a dangerous driving vehicle may include tracking a vehicle-to-vehicle distance; and if the vehicle-to-vehicle distance is within a predefined range or is gradually reduced and then maintained for a predefined period of time or longer, determining at least one vehicle object in a vehicle object pair corresponding to the vehicle-to-vehicle distance as the dangerous driving vehicle.

In the method, determining a vehicle as a dangerous driving vehicle may include, when a plurality of vehicle objects satisfying the dangerous driving condition are detected, determining, as the dangerous driving vehicle, a vehicle object having a greater speed change, a vehicle object having a speed change greater than a predefined reference value, or a vehicle object having a lane change greater than a predefined number of times within a predefined period of time.

According to an embodiment of the present disclosure, an apparatus for detecting a dangerous driving vehicle may include a server communication circuit and a server processor functionally connected to the server communication circuit. The server processor may be configured to receive a CCTV image of a road, to detect a pair of vehicle objects in the CCTV image, to check whether a movement of the pair of vehicle objects satisfies a predefined dangerous driving condition, and to determine a vehicle having the movement satisfying the dangerous driving condition as a dangerous driving vehicle.

The server processor may be configured to track a change in a vehicle-to-vehicle distance of the vehicle object pair, and if the vehicle-to-vehicle distance change is within a predefined range or is gradually reduced and then maintained for a predefined period of time, to determine at least one vehicle object in the vehicle object pair as the dangerous driving vehicle.

The server processor may be configured to determine, as the dangerous driving vehicle, a vehicle object having a greater speed change in the vehicle object pair.

The server processor may be configured to determine, as the dangerous driving vehicle, a vehicle object having a speed change greater than a predefined reference value in the vehicle object pair.

The server processor may be configured to determine, as the dangerous driving vehicle, a vehicle object having a lane change greater than a predefined number of times within a predefined period of time in the vehicle object pair.

The server processor may be configured to transmit information on the dangerous driving vehicle to a user terminal of an administrator managing the road, or to collect vehicle information on the dangerous vehicle object and transmit a warning for dangerous driving to a user terminal corresponding to the vehicle information.

According to an embodiment of the present disclosure, a method for detecting a dangerous driving vehicle is performed by a server processor of a dangerous driving vehicle detection apparatus. The method may include receiving a CCTV image of a road; detecting a pair of vehicle objects in the CCTV image; checking whether a movement of the pair of vehicle objects satisfies a predefined dangerous driving condition; and determining a vehicle having the movement satisfying the dangerous driving condition as a dangerous driving vehicle.

In the method, determining a vehicle as a dangerous driving vehicle may include tracking a change in a vehicle-to-vehicle distance of the vehicle object pair; and if the vehicle-to-vehicle distance change is within a predefined range or is gradually reduced and then maintained for a predefined period of time, determining at least one vehicle object in the vehicle object pair as the dangerous driving vehicle.

In the method, determining a vehicle as a dangerous driving vehicle may include determining, as the dangerous driving vehicle, a vehicle object having a greater speed change in the vehicle object pair.

In the method, determining a vehicle as a dangerous driving vehicle may include determining, as the dangerous driving vehicle, a vehicle object having a speed change greater than a predefined reference value in the vehicle object pair.

In the method, determining a vehicle as a dangerous driving vehicle may include determining, as the dangerous driving vehicle, a vehicle object having a lane change greater than a predefined number of times within a predefined period of time in the vehicle object pair.

The method may further include transmitting information on the dangerous driving vehicle to a user terminal of an administrator managing the road; or collecting vehicle information on the dangerous vehicle object and transmitting a warning for dangerous driving to a user terminal corresponding to the vehicle information.

According to an embodiment of the present disclosure, a method for detecting a cutting-in vehicle may include, by an image processor, receiving a streaming image of a road from an imaging device; by a vehicle detector, detecting a vehicle mask representing a vehicle from a frame of the streaming image through a segmentation model; by a violation analyzer, calculating a degree of overlap between the vehicle mask and a standard mask representing a predetermined road surface marking on the road; and by the violation analyzer, detecting a vehicle corresponding to the detected vehicle mask as a cutting-in vehicle if the degree of overlap is greater than a predetermined value.

In the method, calculating a degree of overlap may include, by the violation analyzer, calculating the degree of overlap between pixels of an area occupied by the standard mask and pixels of an area occupied by the vehicle mask in the frame.

In the method, calculating a degree of overlap may include, by the violation analyzer, calculating the degree of overlap according to Equation,

$$O = \frac{2 {\sum }_{i = 0}^{N} ( {s}_{i} + {c}_{i} ) + ε}{{\sum }_{i = 0}^{N} ( {s}_{i}^{2} + {c}_{i}^{2} ) + ε}$$

where ‘O’ denotes the degree of overlap, ‘N’ denotes a number of pixels, ‘i’ denotes an index of a pixel, ‘s’ denotes a pixel of an area occupied by the standard mask, ‘c’ denotes a pixel of an area occupied by the vehicle mask, and ‘ε’ is a hyper-parameter.

In the method, detecting a vehicle mask may include, by the vehicle detector, inputting the frame to the segmentation model; and by the segmentation model, detecting the vehicle mask representing the vehicle in the frame by performing a plurality of operations for applying trained weights to pixels included in the frame.

The method may further include, before receiving the streaming image of the road, by the image processor, upon receiving streaming images obtained by capturing an area including a road surface marking from the imaging device, extracting a plurality of frames from the streaming images and sequentially providing the extracted frames; by a standard setter, deriving a segmented image including a mask indicating the road surface marking from a frame in which no mask for other object is detected among the extracted frames through a segmentation model; by the standard setter, checking whether the segmented image includes a mask of other object other than the mask indicating the road surface marking; and by the standard setter, if no mask of other object other than the mask indicating the road surface marking is included, setting the mask indicating the road surface marking as a standard mask.

In the method, setting the mask as a standard mask may include, by the standard setter, setting pixel coordinates of an area occupied by the detected mask as the standard mask.

The method may further include, before receiving the streaming image of the road, by a model generator, preparing learning data including an image and a target image, the image containing at least one object among a road surface marking and a vehicle, and the target image containing a mask having pixel values that distinguish each object contained in the image from other objects; by the model generator, inputting the image to a segmentation model whose learning is uncompleted; by the segmentation model, segmenting the objects contained in the image through a plurality of operations for applying untrained weights to the image, thereby deriving a segmented image containing a mask having pixel values that distinguish each object from other objects; by the model generator, calculating a loss representing a difference between the segmented image and the target image; and by the model generator, performing optimization to modify the weights of the segmentation model so that the loss is minimized.

According to an embodiment of the present disclosure, an apparatus for detecting a cutting-in vehicle may include an image processor configured to receive a streaming image of a road from an imaging device; a vehicle detector configured to detect a vehicle mask representing a vehicle from a frame of the streaming image through a segmentation model; and a violation analyzer configured to calculate a degree of overlap between the vehicle mask and a standard mask representing a predetermined road surface marking on the road, and to detect a vehicle corresponding to the detected vehicle mask as a cutting-in vehicle if the degree of overlap is greater than a predetermined value.

The violation analyzer may be configured to calculate the degree of overlap between pixels of an area occupied by the standard mask and pixels of an area occupied by the vehicle mask in the frame.

The violation analyzer may be configured to calculate the degree of overlap according to Equation,

$$O = \frac{2 {\sum }_{i = 0}^{N} ( {s}_{i} + {c}_{i} ) + ε}{{\sum }_{i = 0}^{N} ( {s}_{i}^{2} + {c}_{i}^{2} ) + ε}$$

where ‘O’ denotes the degree of overlap, ‘N’ denotes a number of pixels, ‘i’ denotes an index of a pixel, ‘s’ denotes a pixel of an area occupied by the standard mask, ‘c’ denotes a pixel of an area occupied by the vehicle mask, and ‘ε’ is a hyper-parameter.

The violation analyzer may be configured to input the frame to the segmentation model, and the segmentation model may be configured to detect the vehicle mask representing the vehicle in the frame by performing a plurality of operations for applying trained weights to pixels included in the frame.

The image processor may be configured to, upon receiving streaming images obtained by capturing an area including a road surface marking from the imaging device, extract a plurality of frames from the streaming images and sequentially providing the extracted frames, and the apparatus may further include a standard setter configured to derive a segmented image including a mask indicating the road surface marking from a frame in which no mask for other object is detected among the extracted frames through a segmentation model, to check whether the segmented image includes a mask of other object other than the mask indicating the road surface marking, and if no mask of other object other than the mask indicating the road surface marking is included, to set the mask indicating the road surface marking as a standard mask.

The standard setter may be configured to set pixel coordinates of an area occupied by the detected mask as the standard mask.

The apparatus may further include a model generator configured to prepare learning data including an image and a target image, the image containing at least one object among a road surface marking and a vehicle, and the target image containing a mask having pixel values that distinguish each object contained in the image from other objects, to input the image to a segmentation model whose learning is uncompleted, when the segmentation model segments the objects contained in the image through a plurality of operations for applying untrained weights to the image, and thereby derives a segmented image containing a mask having pixel values that distinguish each object from other objects, to calculate a loss representing a difference between the segmented image and the target image, and to perform optimization to modify the weights of the segmentation model so that the loss is minimized.

According to an embodiment of the present disclosure, a method for detecting a cutting-in vehicle may include, by a data processor, receiving streaming images of a road from an imaging device; by a vehicle detector, detecting one or more vehicles through a bounding box in a plurality of frames of the streaming images using a detection model; and by the vehicle detector, detecting a cutting-in vehicle based on whether a vehicle not detected in a first frame among the plurality of frames is detected in a second frame subsequent to the first frame.

In the method, detecting a cutting-in vehicle may include, by the vehicle detector, detecting at least one first vehicle driving in one lane in a first frame among the plurality of frames; by the vehicle detector, checking whether a second vehicle located in front of the first vehicle is detected in a second frame subsequent to the first frame; and by the vehicle detector, if the second vehicle is detected, recognizing the detected second vehicle as the cutting-in vehicle.

The method may further include, by a speeding detector, when the cutting-in vehicle is detected, continuously detecting the cutting-in vehicle through a bounding box in a plurality of frames using the detection model; by the speeding detector, selecting two different frames from among frames in which the cutting-in vehicle is detected; by the speeding detector, calculating a travel distance of the cutting-in vehicle from a distance between the bounding boxes of the cutting-in vehicle in the selected two frames; by the speeding detector, calculating a travel time of the cutting-in vehicle by applying a frame rate of the streaming images to a number of the frames in which the cutting-in vehicle is detected; by the speeding detector, calculating a speed of the cutting-in vehicle based on the travel distance and the travel time; and by the speeding detector, determining whether the cutting-in vehicle is speeding based on the calculated speed.

In the method, calculating a travel distance of the cutting-in vehicle may include, by the speeding detector, converting pixel coordinates of a center of a bounding box of each of the selected two frames into ground-truth coordinates using a homography; and by the speeding detector, calculating the travel distance of the cutting-in vehicle from a distance of the ground-truth coordinates.

In the method, calculating a travel distance of the cutting-in vehicle may include, by the speeding detector, calculating the travel distance of the cutting-in vehicle according to Equation,

$$D = \sqrt{{( {x}_{2} - {x}_{1} )}^{2} - {( {y}_{2} - {y}_{1} )}^{2}}$$

where ‘D’ denotes the travel distance of the cutting-in vehicle, ‘x1’ and ‘y1’ are the ground-truth coordinates converted from the pixel coordinates of the center of the bounding box of the first frame among the selected frames, and ‘x2’ and ‘y2’ are the ground-truth coordinates converted from the pixel coordinates of the center of the bounding box of the second frame among the selected frames.

The method may further include, before receiving the streaming images, by a model generator, preparing learning data including an image and a label, the image containing a vehicle, and the label containing a ground-truth box indicating an area occupied by the vehicle in the image; by the model generator, inputting the image into a detection model whose learning is uncompleted; by the detection model, detecting a bounding box representing an area occupied by the vehicle in the image through a plurality of operations for applying untrained weights to the image; by the model generator, calculating a loss representing a difference between the detected bounding box and the ground-truth box of the label; and by the model generator, performing optimization by modifying the weights of the detection model so that the loss is minimized.

According to an embodiment of the present disclosure, an apparatus for detecting a cutting-in vehicle may include a data processor configured to receive streaming images of a road from an imaging device; and a vehicle detector configured to detect one or more vehicles through a bounding box in a plurality of frames of the streaming images using a detection model, and to detect a cutting-in vehicle based on whether a vehicle not detected in a first frame among the plurality of frames is detected in a second frame subsequent to the first frame.

The vehicle detector may be configured to detect at least one first vehicle driving in one lane in a first frame among the plurality of frames, to check whether a second vehicle located in front of the first vehicle is detected in a second frame subsequent to the first frame, and if the second vehicle is detected, to recognize the detected second vehicle as the cutting-in vehicle.

The apparatus may further include a speeding detector configured to, when the cutting-in vehicle is detected, continuously detect the cutting-in vehicle through a bounding box in a plurality of frames using the detection model, select two different frames from among frames in which the cutting-in vehicle is detected, to calculate a travel distance of the cutting-in vehicle from a distance between the bounding boxes of the cutting-in vehicle in the selected two frames, to calculate a travel time of the cutting-in vehicle by applying a frame rate of the streaming images to a number of the frames in which the cutting-in vehicle is detected, to calculate a speed of the cutting-in vehicle based on the travel distance and the travel time, and to determine whether the cutting-in vehicle is speeding based on the calculated speed.

The speeding detector may be configured to convert pixel coordinates of a center of a bounding box of each of the selected two frames into ground-truth coordinates using a homography, and to calculate the travel distance of the cutting-in vehicle from a distance of the ground-truth coordinates.

The speeding detector may be configured to calculate the travel distance of the cutting-in vehicle according to Equation,

$$D = \sqrt{{( {x}_{2} - {x}_{1} )}^{2} - {( {y}_{2} - {y}_{1} )}^{2}}$$

where ‘D’ denotes the travel distance of the cutting-in vehicle, ‘x1’ and ‘y1’ are the ground-truth coordinates converted from the pixel coordinates of the center of the bounding box of the first frame among the selected frames, and ‘x2’ and ‘y2’ are the ground-truth coordinates converted from the pixel coordinates of the center of the bounding box of the second frame among the selected frames.

The apparatus may further include a model generator configured to prepare learning data including an image and a label, the image containing a vehicle, and the label containing a ground-truth box indicating an area occupied by the vehicle in the image, to input the image into a detection model whose learning is uncompleted, when the detection model detects a bounding box representing an area occupied by the vehicle in the image through a plurality of operations for applying untrained weights to the image, to calculate a loss representing a difference between the detected bounding box and the ground-truth box of the label, and to perform optimization by modifying the weights of the detection model so that the loss is minimized.

### DESCRIPTION OF DRAWINGS

FIG. 1 is a schematic diagram illustrating one example of an environment for detecting a dangerous driving vehicle according to the first embodiment of the present disclosure.

FIG. 2 is a block diagram illustrating the configuration of a camera-equipped drone as a movable photographing device according to the first embodiment of the present disclosure.

FIG. 3 is a block diagram illustrating the configuration of a dangerous driving vehicle detection apparatus according to the first embodiment of the present disclosure.

FIG. 4 is a schematic diagram illustrating another example of an environment for detecting a dangerous driving vehicle according to the first embodiment of the present disclosure.

FIG. 5 is a flowchart illustrating one example of a dangerous driving vehicle detection method according to the first embodiment of the present disclosure.

FIG. 6 is a flowchart illustrating another example of a dangerous driving vehicle detection method according to the first embodiment of the present disclosure.

FIG. 7 is a schematic diagram illustrating an environment for detecting a dangerous driving vehicle according to the second embodiment of the present disclosure.

FIG. 8 is a block diagram illustrating the configuration of a controller for a fixed-type photographing device according to the second embodiment of the present disclosure.

FIG. 9 is a block diagram illustrating the configuration of a dangerous driving vehicle detection apparatus according to the second embodiment of the present disclosure.

FIG. 10 is a flowchart illustrating one example of a dangerous driving vehicle detection method according to the second embodiment of the present disclosure.

FIG. 11 is a flowchart illustrating another example of a dangerous driving vehicle detection method according to the second embodiment of the present disclosure.

FIG. 12 is a schematic diagram illustrating a system for detecting a cutting-in vehicle according to the third embodiment of the present disclosure.

FIG. 13 is a block diagram illustrating the configuration of a cutting-in vehicle detection apparatus according to the third embodiment of the present disclosure.

FIG. 14 is a flowchart illustrating a method for generating a segmentation model for cutting-in vehicle detection according to the third embodiment of the present disclosure.

FIG. 15 is a diagram illustrating learning data for generating the segmentation model shown in FIG. 14.

FIG. 16 is a flowchart illustrating a method for setting a standard mask for cutting-in vehicle detection according to the third embodiment of the present disclosure.

FIGS. 17A and 17B are screen examples illustrating the standard mask setting method shown in FIG. 16.

FIG. 18 is a flowchart illustrating a cutting-in vehicle detection method according to the third embodiment of the present disclosure.

FIGS. 19A, 19B, 20A, 20B and 20C are screen examples illustrating the cutting-in vehicle detection method shown in FIG. 18.

FIG. 21 is a schematic diagram illustrating a system for detecting a cutting-in vehicle according to the fourth embodiment of the present disclosure.

FIG. 22 is a block diagram illustrating the configuration of a cutting-in vehicle detection apparatus according to the fourth embodiment of the present disclosure.

FIG. 23 is a flowchart illustrating a method for generating a detection model for cutting-in vehicle detection according to the fourth embodiment of the present disclosure.

FIG. 24 is a diagram illustrating learning data for generating the detection model shown in FIG. 23.

FIG. 25 is a flowchart illustrating a cutting-in vehicle detection method according to the fourth embodiment of the present disclosure.

FIG. 26 is an example screen illustrating the cutting-in vehicle detection method shown in FIG. 25.

FIGS. 27 and 28 are example screens illustrating a speed calculation method for cutting-in vehicle detection according to the fourth embodiment of the present disclosure.

FIG. 29 is an example diagram illustrating a hardware system for implementing the apparatus according to the first to fourth embodiments of the present disclosure.

### DETAILED DESCRIPTION

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present disclosure. Also, the terms “comprise”, “include”, “have”, and derivatives thereof mean inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In the description and claims, the term “network” is defined as one or more data links that enable electronic data to be transmitted between computer systems and/or modules. When any information is transferred or provided to a computer system via a network or other (wired, wireless, or a combination thereof) communication connection, this connection can be understood as a computer-readable medium. The computer-readable instructions include, for example, instructions and data that cause a general purpose computer system or special purpose computer system to perform a particular function or group of functions. The computer-executable instructions may be binary, intermediate format instructions, such as, for example, an assembly language, or even source code.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

### First Embodiment

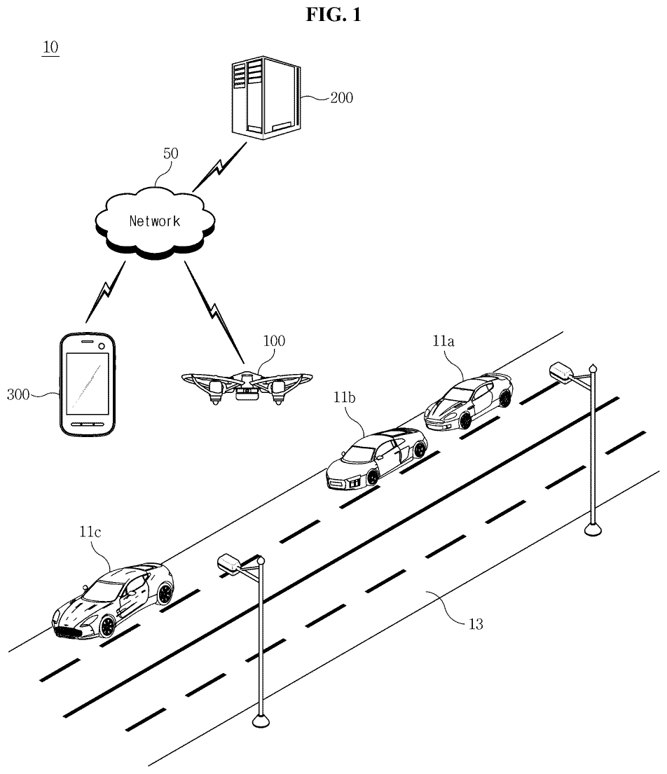

Hereinafter, the first embodiment of the present disclosure will be described with reference to FIGS. 1 to 6.

FIG. 1 is a schematic diagram illustrating one example of an environment for detecting a dangerous driving vehicle according to the first embodiment of the present disclosure.

The environment 10 for detecting (or monitoring) a dangerous driving vehicle shown in FIG. 1 includes at least one movable photographing device 100 for capturing images of vehicles 11a, 11b, and 11c driving on a road 13. In FIG. 1, the movable photographing device 100 is, for example, a camera-equipped drone (hereinafter referred to as a drone). The dangerous driving vehicle detection environment 10 further includes a dangerous driving vehicle detection apparatus 200 (which may also be referred to as a monitoring device or a server), a network 50, and a user terminal 300.

The road 13 may include particular areas where images are captured by the drone 100. The vehicles 11a, 11b, and 11c (or at least one vehicle) may drive on the road 13. A plurality of lanes including a stop line or a center line may be arranged (or printed) on the road 13. The vehicles 11a, 11b, and 11c may drive along at least one of the plurality of lanes arranged on the road 13 and may often change lanes to overtake another vehicle or drive on another road. Additionally, bumps may be arranged on the road 13 to control the driving speed of the vehicles 11a, 11b, and 11c, a sign including information indicating a speed limit may be arranged, or speed limit information may be arranged (or printed).

The vehicles 11a, 11b, and 11c may change lanes or drive at an accelerated speed/constant speed/decelerated speed while driving on the road 13. In the drawing, three vehicles 11a, 11b, and 11c are shown, but a smaller or larger number of vehicles may drive on the road 13. A certain one of the vehicles 11a, 11b, and 11c may drive dangerously or recklessly, violating traffic laws.

At least one of the vehicles 11a, 11b, and 11c may include a vehicle communication circuit and a system capable of driving the same, and thus may receive messages from a base station, a satellite, or other electronic devices disposed around the road 13 through a communication channel. At least one of the vehicles 11a, 11b, and 11c may include a vehicle output device (e.g., at least one of a vehicle display device or a vehicle audio device). The vehicle output device may output information stored in a vehicle memory or information received through the vehicle communication circuit. As an example, at least one of the vehicles 11a, 11b, and 11c may receive a message related to dangerous driving from at least one of the dangerous driving vehicle detection apparatus 200, the user terminal 300, and the drone 100, and may output the received message to the vehicle output device.

The drone 100 may move to a specific area of the road 13 based on pre-stored coordinate information, capture an image of the specific area of the road 13, and then provide the captured image to the dangerous driving vehicle detection apparatus 200. Alternatively, the drone 100 may form a communication channel with the dangerous driving vehicle detection apparatus 200, then move to a specific area of the road 13 based on coordinate information provided by the dangerous driving vehicle detection apparatus 200, collect captured images from the specific area, and provide the collected images to the dangerous driving vehicle detection apparatus 200. In an example, the coordinate information may include latitude, longitude, and altitude information. In an example, the drone 100 may analyze the collected images and, if a vehicle object corresponding to a dangerous driving vehicle is detected, provide the collected captured images to the dangerous driving vehicle detection apparatus 200.

The dangerous driving vehicle detection apparatus 200 may receive captured images (or at least one captured image) of the road 13 from the drone 100 and, based on the received captured images, determine whether a dangerous driving vehicle exists. In this regard, the dangerous driving vehicle detection apparatus 200 may check information received through various routes and, if there is a report regarding dangerous driving of a vehicle in the received information, control the drone 100 to move to an area corresponding to the report. Alternatively, the dangerous driving vehicle detection apparatus 200 may move the drone 100 to monitor a specific area of the road 13 at a certain interval or in real time. If the specific area of the road 13 is a real-time monitoring area, the dangerous driving vehicle detection apparatus 200 may operate a plurality of drones alternately to perform real-time monitoring of the specific area of the road 13.

The dangerous driving vehicle detection apparatus 200 may collect information on a dangerous driving vehicle (e.g., at least one of a vehicle model, vehicle license plate information, and a vehicle color) when the dangerous driving vehicle exists on the road 13, and issue a warning about dangerous driving based on the collected vehicle information. For example, the dangerous driving vehicle detection environment 10 may include an audio device (not shown) installed on the road 13 to broadcast warning information so that drivers of the vehicles 11a, 11b, and 11c can hear it. Alternatively or additionally, the dangerous driving vehicle detection environment 10 may include a display device (not shown) installed on the road 13 to display warning information so that drivers of the vehicles 11a, 11b, and 11c can see it. The dangerous driving vehicle detection apparatus 200 may form a communication channel with at least one of the audio device and the display device, and provide warning information to at least one of the audio device and the display device. Alternatively, the dangerous driving vehicle detection apparatus 200 may transmit a warning message using a base station (not shown) located near an area where a dangerous driving vehicle is present. Alternatively, the dangerous driving vehicle detection apparatus 200 may control the drone 100 to output warning information. In this case, the drone 100 may further include an audio device.

The user terminal 300 may be a terminal of an administrator managing the road 13 (e.g., a terminal carried by a member of a road patrol unit). The user terminal 300 may receive information about a dangerous driving vehicle from the dangerous driving vehicle detection apparatus 200. In this case, the user terminal 300 may output the received information about the dangerous driving vehicle together with a warning message on a terminal display. Alternatively or additionally, the user terminal 300 may be a portable terminal carried by a driver and/or a passenger of the vehicle 11a, 11b, or 11c. The user terminal 300 may receive a warning message about dangerous driving from a base station adjacent to the road 13 (or having a communication coverage capable of transmitting the message to a specific area of the road 13). When receiving a warning message, the user terminal 300 may output the received warning message on a terminal display or output it to a vehicle output device connected to the user terminal 300 through a communication channel. In this regard, the user terminal 300 may include a terminal communication circuit capable of communicating with the network 50, a terminal processor that forms a communication channel with the dangerous driving vehicle detection apparatus 200 through the network 50 and controls receiving and outputting information or messages provided by the dangerous driving vehicle detection apparatus 200, a terminal display capable of outputting the received information, and may further include a terminal memory for storing data related to the aforementioned operation.

The network 50 may support the formation of a communication channel among the drone 100, the dangerous driving vehicle detection apparatus 200, and the user terminal 300. The network 50 may include, for example, a communication element that supports a wired connection or a wireless connection between at least two of the drone 100, the dangerous driving vehicle detection apparatus 200, and the user terminal 300. In an example, the network 50 may wirelessly connect between the drone 100 and the reckless driving detection device 200 or between the dangerous driving vehicle detection apparatus 200 and the user terminal 300. In this regard, the network 50 may include at least one base station and a base station controller. The network 50 is not limited to a specific communication scheme (or communication generation), and may include communication equipment that supports at least one of various communication schemes for signal flow among the drone 100, the dangerous driving vehicle detection apparatus 200, and the user terminal 300.

Meanwhile, the above description was made that when the drone 100 obtains a captured image (e.g., at least one of an RGB image, a thermal image, and a spectral image) and transmits it to the dangerous driving vehicle detection apparatus 200 via the network 50, and then the dangerous driving vehicle detection apparatus 200 analyzes the received image to detect a dangerous driving vehicle, the present disclosure is not limited thereto. Alternatively or additionally, when the drone 100 collects and analyzes vehicle images and detects a dangerous driving vehicle from a certain image, the image is provided to the dangerous driving vehicle detection apparatus 200. In this way, the dangerous driving vehicle detection environment 10 according to the first embodiment of the present disclosure allows the drone 100 and/or the dangerous driving vehicle detection apparatus 200 to perform a detection operation for a dangerous driving vehicle.

FIG. 2 is a block diagram illustrating the configuration of a camera-equipped drone as a movable photographing device according to the first embodiment of the present disclosure.

Referring to FIG. 2, the camera-equipped drone 100 (hereinafter referred to as a drone) may include a camera 101, a communication circuit 110, a memory 120, a flight module 130, and a controller 150.

The camera 101 may include an image sensor that can be installed on the drone 100. In addition, the camera 101 may have a zoom function. Additionally, the camera 101 may further include a module that can rotate. For example, the camera 101 may include a rotation module that can rotate the shooting direction up, down, left, and right. The camera 101 may capture a wide-area image of a specific area of the road 13 under the control of the controller 150, or may designate a specific vehicle and capture an image of the designated vehicle. The captured image may be a still image or a moving image.

The communication circuit 110 may include at least one communication module for establishing a communication channel of the drone 100. For example, the communication circuit 110 may include a communication module for a communication connection with the network 50. The communication circuit 110 may form a communication channel with the dangerous driving vehicle detection apparatus 200 and transmit the image captured by the camera 101 to the dangerous driving vehicle detection apparatus 200 based on predefined schedule information or in response to the control of the controller 150. In another example, the communication circuit 110 may receive a control signal related to the movement control of the drone 100 and a control signal for the shooting control of the camera 101 from the dangerous driving vehicle detection apparatus 200.

The flight module 130 may include components for moving the drone 100. In an example, the flight module 130 may include a plurality of propellers, a propeller driving motor, and a battery for supplying power to the motor. Alternatively, the flight module 130 may be configured to generate power through a combustion action of a combustion device and rotate the propeller based on the generated power. The flight module 130 may move to a designated location in response to the control of the controller 150. The designated location may include an aerial coordinate for performing shooting for a specific area of the road 13.

The memory 120 may store data or programs related to the operation of the drone 100. In an example, the memory 120 may receive a captured image transmitted in real time by the camera 101 and store it temporarily or semi-permanently. In addition, the memory 120 may store location information about an area monitored by the drone 100. Alternatively or additionally, the memory 120 may store location information about a specific area provided by the dangerous driving vehicle detection apparatus 200.

The controller 150 can perform transmission and processing of signals related to the control of the drone 100 and storage or transmission of the processing results. In an example, when the controller 150 receives a monitoring request signal for the road 13 based on predefined scheduling information or at the request of the dangerous driving vehicle detection apparatus 200, the controller 150 may control the flight module 130 to move the drone 100 to a specified coordinate. In relation to the movement of the drone 100 to the specified coordinate, the drone 100 may include a location information collection sensor (e.g., GPS) and an altitude sensor. Using the location information collection sensor and the altitude sensor, the controller 150 may collect information on current location and altitude at regular intervals. The controller 150 may move the drone 100 to a point where the collected location and altitude information matches the information included in the predefined scheduling information or the information provided by the dangerous driving vehicle detection apparatus 200.

When the drone 100 moves to the specified coordinates, the controller 150 may control the camera 101 to turn on and collect captured images of the road 13. In this regard, the controller 150 may generate a control signal for turning on or turning off the camera 101 and operate the camera 101 according to the generated control signal. In an example, the controller 150 may control the camera 101 to collect captured image of the road 13, and then temporarily or semi-permanently store the collected images in the memory 120 or provide them to the dangerous driving vehicle detection apparatus 200 through the communication circuit 110. In this process, the controller 150 may perform a brief analysis on the captured image of the road 13 to determine whether a vehicle object is detected in the captured image. If a vehicle object is detected in the captured image, the controller 150 may provide the captured image to the dangerous driving vehicle detection apparatus 200. If a vehicle object is not detected in the captured image, the controller 150 may provide a message indicating that there is no vehicle on the road 13 to the dangerous driving vehicle detection apparatus 200.

In another example, when a vehicle object is detected in the captured image, the controller 150 may collect driving information of the vehicle object (e.g., at least one of speed change information of the vehicle object during a specified period of time, lane change information of the vehicle object during a specified period of time, and distance change information between vehicle objects during a specified period of time). When the driving information of the vehicle object deviates from a predefined threshold range, the controller 150 may provide the captured image to the dangerous driving vehicle detection apparatus 200. When the driving information of the vehicle object is within the predefined threshold range, the controller 150 may create a message corresponding to the absence of a dangerous driving vehicle and provide the created message to the dangerous driving vehicle detection apparatus 200.

Additionally, the drone 100 may further include an audio device (not shown). If a vehicle object having driving information exceeding a predefined threshold range is detected, the controller 150 may output a warning about dangerous driving for the corresponding vehicle through the audio device. In this regard, the drone 100 may perform a warning about dangerous driving through the audio device after approaching the dangerous driving vehicle within a predefined distance. Alternatively, if the dangerous driving vehicle detection apparatus 200 is set to determine whether a vehicle is a dangerous driving vehicle, the drone 100 may receive information about a dangerous driving vehicle from the dangerous driving vehicle detection apparatus 200 and, based on the received information, approach the corresponding vehicle (e.g., within 5 m) to perform a warning about dangerous driving.

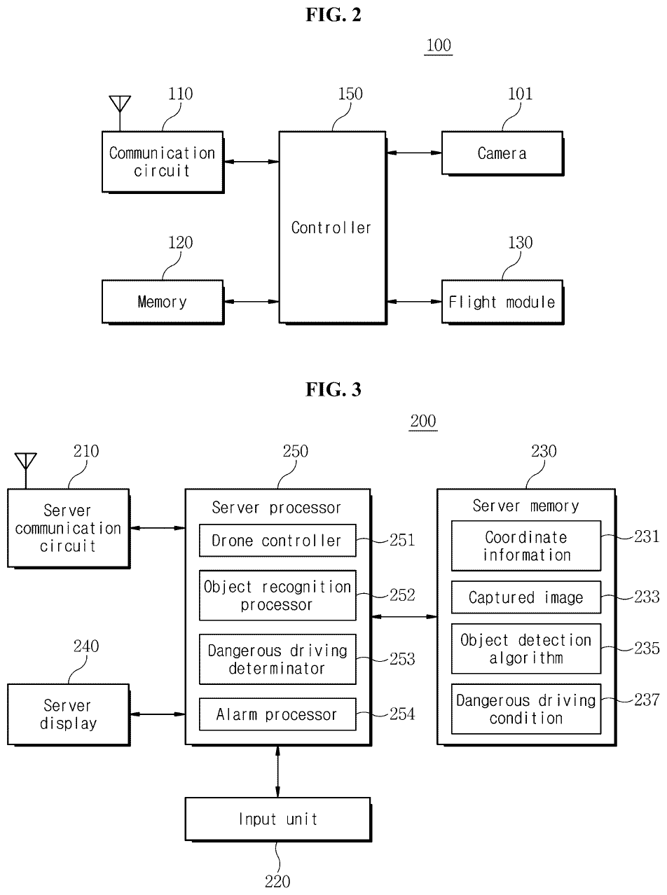

FIG. 3 is a block diagram illustrating the configuration of a dangerous driving vehicle detection apparatus according to the first embodiment of the present disclosure.

Referring to FIG. 3, the dangerous driving vehicle detection apparatus 200 (or referred to as a monitoring device or a server) may include a server communication circuit 210, an input unit 220, a server memory 230, a server display 240, and a server processor 250.

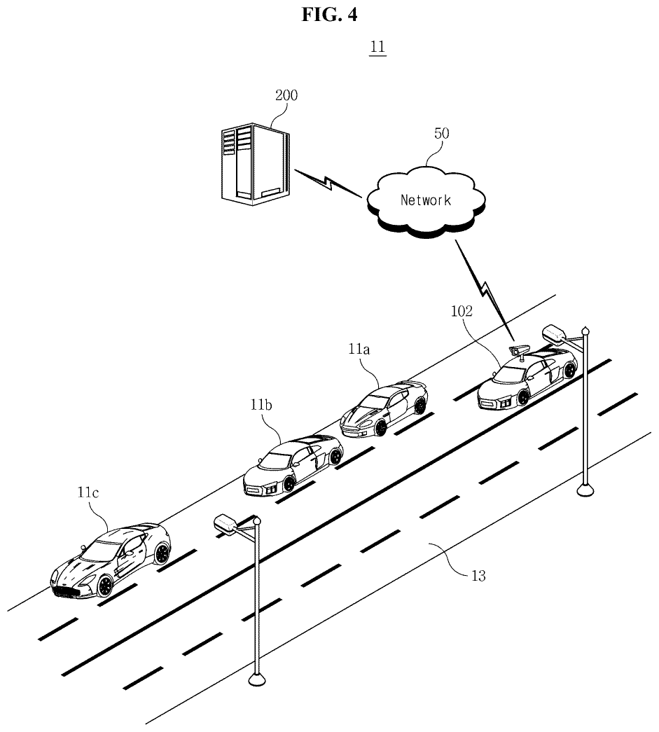

The server communication circuit 210 may support the formation of a communication channel of the dangerous driving vehicle detection apparatus 200. In an example, the server communication circuit 210 may include a first communication circuit capable of forming a communication channel with the movable photographing device (e.g., a camera-equipped drone 100 or a camera-equipped vehicle 102 shown in FIG. 4 described below, the following description using the drone 100 is similarly applied to the camera-equipped vehicle 102) through the network 50, and a second communication circuit capable of forming a communication channel with the user terminal 300 through the network 50. When the server communication circuit 210 forms a communication channel with the drone 100 and the user terminal 300 through the same type of communication scheme, the server communication circuit 210 may be configured as a single communication circuit. In an example, the server communication circuit 210 may receive a captured image from the drone 100 in real time or at regular intervals. Meanwhile, if the drone 100 is designed to determine whether a vehicle is being driven dangerously, the server communication circuit 210 may receive from the drone 100 information on whether a specific vehicle is being driven dangerously and vehicle identification information.

The input unit 220 may include components that support administrator's inputs related to the operation of the dangerous driving vehicle detection apparatus 200. For example, the input unit 220 may include at least one of various input devices such as a keyboard, a keypad, a mouse, a touchscreen, a touchpad, a touch key, a voice input device, a gesture input device, a joystick, and a wheel device. The input unit 220 may generate, in response to administrator's manipulation, at least one input signal from among an input signal requesting a communication connection with the drone 100, an input signal inputting specific location information (or coordinate information) of the road 13 to the drone 100, an input signal requesting transmission of captured images from the drone 100 (this may be omitted if the drone 100 is set to automatically transmit captured images), an input signal requesting detection of a dangerous driving vehicle in the received captured images, an input signal indicating a warning when a dangerous driving vehicle exists, and an input signal requesting output of a dangerous driving warning through the drone 100, and then transmit the generated input signal to the server processor 250.

The server memory 230 may store at least one of data and programs related to the operation of the dangerous driving vehicle detection apparatus 200. For example, the server memory 230 may include at least one of coordinate information 231, a captured image 233, an object detection algorithm 235, and dangerous driving conditions 237. The coordinate information 231 indicates a location where the drone 100 should collect a captured image, and the captured image 233 indicates an image captured and transmitted by the drone 100. In an example, the coordinate information 231 may include latitude, longitude, and altitude information in the case of the drone 100, and may include only latitude and longitude information in the case of the camera-equipped vehicle 102 shown in FIG. 4. The coordinate information 231 may be entered and stored by an administrator using the input unit 220. Alternatively or additionally, the coordinate information 231 may be stored temporarily or semi-permanently according to a report of a dangerous driving incident. Alternatively or additionally, the coordinate information 231 may be pre-stored as locations where dangerous driving occurs statistically frequently. The captured image 233 may be all captured images provided in real time by the drone 100 for the road 13. Alternatively, the captured image 233 may include only images containing at least one vehicle object. The object detection algorithm 235 is an algorithm or program capable of detecting at least one of vehicles object 11a, 11b, and 11c contained in the captured image 233. The dangerous driving conditions 237 is a condition to be used for determining that at least one vehicle detected by the object detection algorithm 235 is driving dangerously. In an example, the dangerous driving conditions 237 may include at least one of a speed change condition, a vehicle-to-vehicle distance condition, and the number of lane changes condition regarding a driving vehicle.

The server display 240 may output at least one screen related to the operation of the dangerous driving vehicle detection apparatus 200. For example, the server display 240 may output at least one screen from among a screen indicating a connection status with the drone 100, a screen indicating a current status of the drone 100, a screen displaying information related to the drone 100 currently operating, a screen displaying the captured image 233 received in real time from the drone 100, a screen marking at least one vehicle 11a, 11b, and/or 11c detected from the captured image 233, a screen marking at least one vehicle 11a, 11b, and/or 11c satisfying the dangerous driving conditions 237, a screen displaying vehicle information of at least one vehicle 11a, 11b, and/or 11c satisfying the dangerous driving conditions 237, and a screen displaying a warning to a vehicle undergoing dangerous driving.

The server processor 250 may perform operations of receiving, transmitting, and processing signals related to the operation of the dangerous driving vehicle detection apparatus 200, and storing or transmitting the processing results. For example, the server processor 250 may receive the captured image 233 from the drone 100 based on predefined scheduling information or in response to an administrator's input, detect at least one vehicle object from the received captured image 233, and determine whether at least one detected vehicle is driving dangerously. Additionally, the server processor 250 may perform processing for a warning when a dangerously driving vehicle is detected.

Specifically, the server processor 250 may include a drone controller 251 (or a camera-equipped vehicle controller, hereinafter referred to as the drone controller), an object recognition processor 252, a dangerous driving determinator 253, and an alarm processor 254.

The drone controller 251 may generate a control signal related to controlling the drone 100 and transmit the generated control signal to the drone 100 through the network 50. In an example, the drone controller 251 may collect information on reports of dangerous driving, identify a location indicated in the collected reports, and map the identified location onto a map to collect latitude and longitude information in the coordinate information 231. At this time, the drone controller 251 may set altitude information to a predefined altitude. Alternatively, the drone controller 251 may obtain the coordinate information 231 designated as a surveillance area of the road 13 based on predefined scheduling information and provide the obtained coordinate information 231 to the drone 100. Upon receiving feedback information from the drone 100 positioned at a location indicated by the coordinate information 231, the drone controller 251 may control image capturing or control a request for the captured image 233. Upon receiving the captured image 233 from the drone 100, the drone controller 251 may temporarily or semi-permanently store the received captured image 233 in the server memory 230. Upon receiving the captured image 233 from the drone 100 for a specified period of time, the drone controller 251 may command the drone 100 to return. When real-time monitoring is required for a specific area of the road 13, the drone controller 251 may continuously control monitoring of the specific area by operating a plurality of drones alternately. When a vehicle under surveillance due to dangerous driving is moving, the drone controller 251 may control the drone 100 to track the corresponding vehicle. In one example, when there are a plurality of movable photographing devices (e.g., the drones 100, or the camera-equipped vehicles 102 shown in FIG. 4), the drone controller 251 may determine which device to dispatch based on the location (e.g., coordinate information) from which the captured image is to be acquired. In this regard, the drone controller 251 may obtain location information of each of the plurality of movable photographing devices, compare the location information with the coordinate information from which the captured image is to be acquired, and provide the coordinate information to the movable photographing device at the shortest distance.

The object recognition processor 252 may perform object recognition in the captured image 233 received from the drone 100 and stored in the server memory 230 under the control of the drone controller 251. In this regard, the object recognition processor 252 may call the object detection algorithm 235 stored in the server memory 230 and use the object detection algorithm 235 to determine whether at least one vehicle is driving in the captured image 233. If at least one vehicle is driving, the object recognition processor 252 may detect a vehicle object. The object recognition processor 252 may transmit information about the vehicle object detection to the drone controller 251. The drone controller 251 may remove captured images in which no vehicle object is detected from the server memory 230.

The object recognition processor 252 may create driving information by tracking the movement of the vehicle object based on the acquired captured image. In an example, the driving information may include movement information of a vehicle object pair (e.g., information on change in interval of a vehicle object pair, information on change in speed of a vehicle object pair, and information on lane change). Alternatively or additionally, the driving information may include at least one of lane information, speed information, lane change information, information on rapid speed change exceeding a predefined reference value (e.g., rapid deceleration, rapid acceleration, rapid stop, and rapid start), and information on vehicle exterior protrusion of at least one vehicle 11a, 11b, and/or 11c. The object recognition processor 252 may transmit the driving information of the vehicle object to the dangerous driving determinator 253.

The dangerous driving determinator 253 may receive the driving information from the object recognition processor 252 and, based on the received driving information, determine whether at least one vehicle 11a, 11b, and/or 11c is driving dangerously. In an example, the dangerous driving determinator 253 may obtain movement information (or driving information) of a vehicle object pair from the object recognition processor 252. The dangerous driving determinator 253 may track a change in the vehicle-to-vehicle distance of a selected vehicle object pair and, if the vehicle-to-vehicle distance decreases to or gradually approaches a predefined reference value (e.g., a safety distance specified in traffic laws), determine that a dangerous driving vehicle has occurred. Alternatively or additionally, the dangerous driving determinator 253 may check at least one of whether the time for which a safe distance is not secured between vehicles continues for a predetermined period of time or longer, whether the vehicle-to-vehicle distance continuously decreases as the speed of the preceding vehicle or the following vehicle changes, and whether the preceding and following vehicles change lanes more than a certain number of times while maintaining a spatial relationship. Alternatively or additionally, for a predetermined time interval, the dangerous driving determinator 253 may detect at least one of whether a safe distance is not secured, whether a prohibition on sudden braking is violated, and whether a prohibition on obstructing overtaking is violated. In an example, the dangerous driving determinator 253 may track the vehicle-to-vehicle distance and, if the vehicle-to-vehicle distance is within a predefined range or is gradually reduced and then maintained for a predefined period of time or longer, determine at least one vehicle object in the vehicle object pair as a dangerous driving vehicle. In the pair of vehicle objects, the dangerous driving determinator 253 may determine, as the dangerous driving vehicle, a vehicle object having a greater speed change, a vehicle object having a speed change greater than a predefined reference value, or a vehicle object having a lane change greater than a predefined number of times within a predefined period of time.

When the dangerous driving vehicle is detected, the dangerous driving determinator 253 may obtain vehicle identification information about the detected dangerous driving vehicle and transmit the obtained vehicle identification information to the drone 100. The dangerous driving determinator 253 may request additional captured images related to the dangerous driving vehicle from the drone 100. Then the drone 100 may mark the dangerous driving vehicle based on the vehicle identification information received from the server processor 250, collect captured images while tracking the marked dangerous driving vehicle, and provide the collected captured images to the dangerous driving vehicle detection apparatus 200.

The dangerous driving determinator 253 may receive traffic laws from a certain server providing traffic laws through the server communication circuit 210 and check whether they are updated. The dangerous driving determinator 253 may operate the dangerous driving conditions 237 based on traffic laws pre-stored in the server memory 230. If the traffic laws are updated, the dangerous driving determinator 253 may update the dangerous driving conditions 237 according to the updated traffic laws. In an example, the dangerous driving determinator 253 may change or delete at least one of the dangerous driving conditions 237 or add a new condition. For example, based on the changed traffic laws, the dangerous driving determinator 253 may adjust at least one of a vehicle's lane change criterion, a safe distance between vehicles, and a vehicle's speed change criterion.

The alarm processor 254 may receive information about the occurrence of at least one vehicle object satisfying at least one of the dangerous driving conditions 237 from the dangerous driving determinator 253. If a vehicle object satisfying the dangerous driving condition 237 occurs, the alarm processor 254 may create a related message and transmit it to the user terminal 300. In an example, the alarm processor 254 may create a warning message about dangerous driving and transmit the warning message in a broadcast manner through a base station adjacent to the road 13 on which the dangerous driving vehicle is driving. Alternatively or additionally, the alarm processor 254 may obtain vehicle identification information of a vehicle satisfying the dangerous driving condition 237 through a captured image. Then the alarm processor 254 may transmit a dangerous driving warning message to the user terminal 300 related to the vehicle identification information. Alternatively or additionally, the alarm processor 254 may transmit a warning message to an audio device or a display device installed on the road 13 where the vehicle is driving dangerously. In an example, the alarm processor 254 may provide the dangerous driving warning message to the drone 100. Upon receiving the dangerous driving warning message from the alarm processor 254 and receiving the vehicle identification information from the server processor 250, the drone 100 may approach the corresponding vehicle based on the vehicle identification information and then output the dangerous driving warning message to the dangerous driving vehicle through the audio device. The drone 100 may also continuously output the warning message while tracking the dangerous driving vehicle for a predefined period of time.

FIG. 4 is a schematic diagram illustrating another example of an environment for detecting a dangerous driving vehicle according to the first embodiment of the present disclosure.

The dangerous driving vehicle detection environment 11 shown in FIG. 4 differs from the dangerous driving vehicle detection environment 10 shown in FIG. 1 in that it includes a camera-equipped vehicle 102 instead of the drone 100 shown in FIG. 1 as the movable photographing device. The camera-equipped vehicle 102 refers to a vehicle equipped with a camera or vehicle-type CCTV that acquires captured images of vehicles 11a, 11b, and 11c driving on the road 13.

Excepting that the camera-equipped vehicle 102 is used instead of the drone 100 as the movable photographing device, the environment 11 shown in FIG. 4 is identical to the environment 10 shown in FIG. 1. Therefore, the remaining description will be omitted.

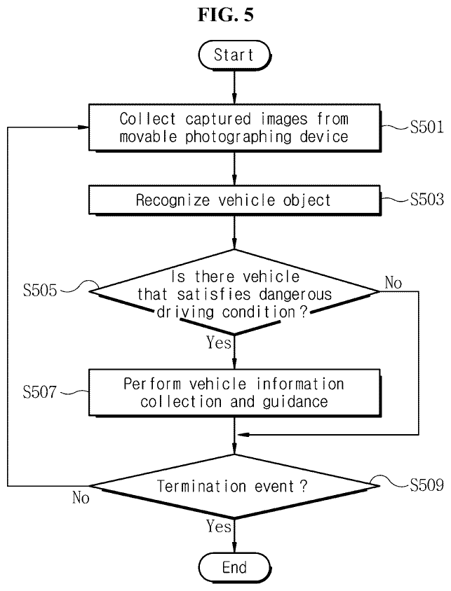

FIG. 5 is a flowchart illustrating one example of a dangerous driving vehicle detection method according to the first embodiment of the present disclosure.

The dangerous driving vehicle detection method according to the first embodiment of the present disclosure is performed by the server processor (250 in FIG. 3) of the dangerous driving vehicle detection apparatus (200 in FIG. 3) described above.

Referring to FIG. 5, in step S501, the server processor 250 collects captured images using a movable photographing device (e.g., at least one of the camera-equipped drone (100 in FIG. 1) or the camera-equipped vehicle (102 in FIG. 4)). For example, the server processor 250 may collect the captured images using the drone 100. In this case, the server processor 250 may form a communication channel with the drone 100 and provide the drone 100 with coordinate information for collecting the captured images. Alternatively, the memory 120 of the drone 100 may store coordinate information for collecting the captured images in advance. For example, the drone 100 may reach a specific area of the road 13 under the control of the server processor 250, collect the captured images, and provide the collected captured images to the server processor 250. Likewise, the server processor 250 may provide coordinate information to the camera-equipped vehicle 102 to collect the captured images of the corresponding area from the camera-equipped vehicle 102.

When collecting the captured images from the movable photographing device, in step S503, the server processor 250 may perform vehicle object recognition from the captured image. In this step, the server processor 250 may use the object detection algorithm 235 stored in the server memory 230 to determine whether at least one vehicle is contained in the captured image. In relation to vehicle object recognition, the server processor 250 may remove a background from the captured image and determine whether at least one vehicle object exists. If at least one vehicle object does not exist, the server processor 250 may not perform the following steps. Then, after a specified time has elapsed, the server processor 250 may return to step S501 and perform the subsequent steps again.

If at least one vehicle object exists in the vehicle object recognition step, in step S505, the server processor 250 may determine whether there is a vehicle object satisfying the dangerous driving condition 237. In an example, the server processor 250 may identify driving information of at least one vehicle. The driving information may include, for example, at least one of information on change in driving speed of the vehicle, information on change in lane of the vehicle, information on change in distance between vehicles, and information on whether a certain thing is thrown from the vehicle. In an example, the server processor 250 may track change in distance between specific vehicle objects based on the driving information and, when the vehicle objects get closer to each other within a predefined safe distance, check sub-conditions for a certain time interval. These sub-conditions may include, for example, whether the time for which the vehicle objects are not securing a safe distance continues for a predetermined time (i.e., whether the safe distance is not secured), whether the vehicle-to-vehicle distance is continuously decreased for a predetermined time due to a change in the speed of the preceding or following vehicle (i.e., whether the safe distance is not secured or whether the prohibition on sudden braking is violated), and whether the preceding and following vehicles continuously change lanes while maintaining a spatial relationship for a predetermined time (i.e., whether the prohibition on overtaking is violated). At least some of the above-described sub-conditions may be changed, added, or deleted according to situations such as revisions to traffic laws.

If there is the vehicle object satisfying the dangerous driving condition, in step S507, the server processor 250 may perform vehicle information collection and guidance (or warning). For example, if there is a vehicle object satisfying at least one of the sub-conditions described above, the server processor 250 may determine the vehicle as a dangerous driving vehicle and, to notify this to a designated administrator, obtain vehicle information and generate a warning message. The vehicle information may include, for example, at least one of the color, type, and license plate of the vehicle. The warning message may contain at least a part of the driving information of the dangerous driving vehicle. The server processor 250 may provide the generated warning message to the designated user terminal 300 (e.g., the user terminal 300 of an administrator managing the road 13 or the user terminal 300 of vehicle passengers driving on the road 13. Alternatively, the server processor 250 may collect only information on whether dangerous driving occurred and the location and time of the dangerous driving and then provide this information to the designated user terminal 300. In an example, the server processor 250 may provide the vehicle information and the dangerous driving warning message to the movable photographing device.

If the dangerous driving condition is not satisfied, the server processor 250 may skip step S507 and check in step S509 whether an event related to process termination occurs. If there is no termination event occurrence, the server processor 250 may return to step S501 and perform subsequent steps again. If there is a termination event occurrence, the server processor 250 may terminate the process. In an example, if no captured image containing the vehicle is received for a predefined time, the server processor 250 may determine that the termination event occurs. Alternatively or additionally, if there is an administrator's input requesting process termination, the server processor 250 may determine that the termination event occurs. When the termination event occurs, the server processor 250 may control to send a return signal to the movable photographing device. If there is no termination event occurrence, the server processor 250 may return to step S501 and perform subsequent steps again.

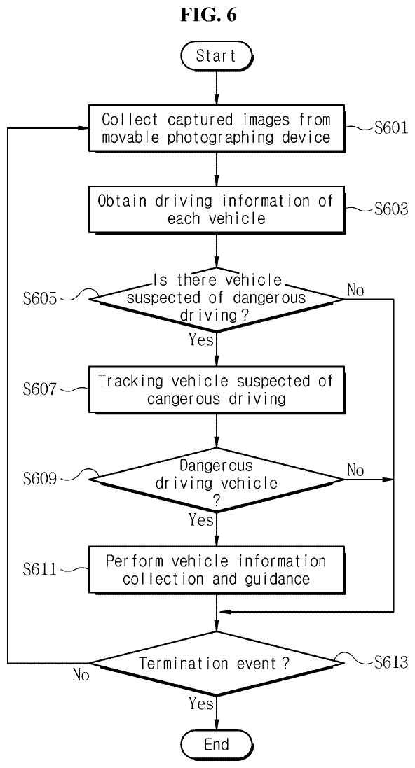

FIG. 6 is a flowchart illustrating another example of a dangerous driving vehicle detection method according to the first embodiment of the present disclosure.

The dangerous driving vehicle detection method shown in FIG. 6 is performed by the server processor (250 in FIG. 3) of the dangerous driving vehicle detection apparatus (200 in FIG. 3) described above.

Referring to FIG. 6, in step S601, the server processor 250 collects captured images from a movable photographing device (e.g., at least one of the camera-equipped drone (100 in FIG. 1) or the camera-equipped vehicle (102 in FIG. 4)). In this regard, the server processor 250 may request and receive the captured images from the movable photographing device in real time or at regular intervals. In an example, the server processor 250 may request the movable photographing device to collect the captured images for a specific area of the road 13 by providing the coordinate information 231 to the movable photographing device or through the coordinate information stored in advance in the movable photographing device.

In step S603, the server processor 250 may obtain driving information for each vehicle contained in the captured image. In this regard, the server processor 250 may obtain driving information for a plurality of vehicles from the captured image by using the object detection algorithm 235 stored in the server memory 230. The driving information may include, for example, at least one of lane information, speed information, lane change information, and vehicle-to-vehicle distance information for each of the vehicles 11a, 11b, and 11c.

In step S605, the server processor 250 may check whether a vehicle suspected of dangerous driving exists. For example, the server processor 250 may check whether at least one of the driving information corresponds to a dangerous driving condition. In this regard, the server processor 250 may previously store suspected dangerous driving vehicle conditions to be used for detection of a suspected dangerous driving vehicle. The suspected dangerous driving vehicle conditions may include a predefined reference value for each of the driving information.

In an example, the server processor 250 may check, from the driving information of the detected vehicle objects, whether there is a case of a sudden change in speed (e.g., sudden deceleration, sudden slowdown, sudden stop, sudden start) exceeding the predefined reference value, whether there is a case of a distance from another vehicle is within a specified distance, whether there is a case of a lane change occurring more than a specified number of times within a predefined first time, or the like.

If there is driving information that satisfies the suspected dangerous driving vehicle conditions, in step S607, the server processor 250 may mark the vehicle suspected of dangerous driving and perform tracking on the marked vehicle. For example, the server processor 250 may collect the driving information on the vehicle suspected of dangerous driving for a predefined time (e.g., a second time greater than the first time).

In step S609, based on the driving information obtained during the predefined second time, the server processor 250 may determine whether the marked vehicle is being driven dangerously. For example, if the driving information of a vehicle corresponding to the dangerous driving suspicion condition maintains the driving state for the second time, the server processor 250 may determine that the vehicle is a dangerous driving vehicle.

In the case of a dangerous driving vehicle, the server processor 250 may perform vehicle information collection and guidance on dangerous driving in step S611. For example, the server processor 250 may broadcast a warning, provide guidance on imposing a fine, or provide information for guidance to the dangerous driving vehicle through at least one of an audio device and a display device installed on the road 13. Alternatively or additionally, the server processor 250 may provide the user terminal 300 of an administrator managing the road 13 with the location and time of dangerous driving and information on the dangerous driving vehicle. Alternatively or additionally, the server processor 250 may collect vehicle information on the dangerous driving vehicle, provide the vehicle information and a warning message on the dangerous driving vehicle to the movable photographing device (e.g., the camera-equipped drone 100 or the camera-equipped car 400), and control the audio device included in the movable photographing device to output the warning message toward the dangerous driving vehicle.

Meanwhile, if there is no vehicle suspected of dangerous driving in step S605, the server processor 250 may skip steps S607 and S609. In addition, if there is no dangerous driving vehicle in step S609, for example, if the vehicle is driven dangerously but then returned to normal driving, the server processor 250 may skip step S611. If there is no dangerous driving vehicle, or after processing the vehicle information collection and guidance due to dangerous driving, the server processor 250 may check in step S613 whether an event related to process termination occurs. If there is no termination event occurrence, the server processor 250 may return to step S601 and perform subsequent steps again. In an example, if no captured image containing a vehicle is received for a predefined time, or if there is an administrator's input requesting a process termination, the server processor 250 may determine that the process termination event occurs. When a process termination event occurs, the server processor 250 may command the return of the movable photographing device (e.g., the camera-equipped drone 100 or the camera-equipped car 400).

Meanwhile, when a report of a vehicle suspected of dangerous driving is received, the server processor 250 may calculate a distance between the current location of the movable photographing device and the reported area, and issue a dispatch order to the movable photographing device with the closest distance. For example, if a report of dangerous driving is received within a predefined distance from the camera-equipped car 400 parked on a certain area of the road 13, the server processor 250 may provide coordinate information on the area to be photographed to the camera-equipped car 400, or if the distance is greater than the predefined distance, the server processor 250 may provide coordinate information on the area to be photographed to the camera-equipped drone 100. Even if the camera-equipped car 400 is located close to the reported area, but if it is in the opposite lane, the server processor 250 may provide coordinate information to the camera-equipped drone 100.

### Second Embodiment

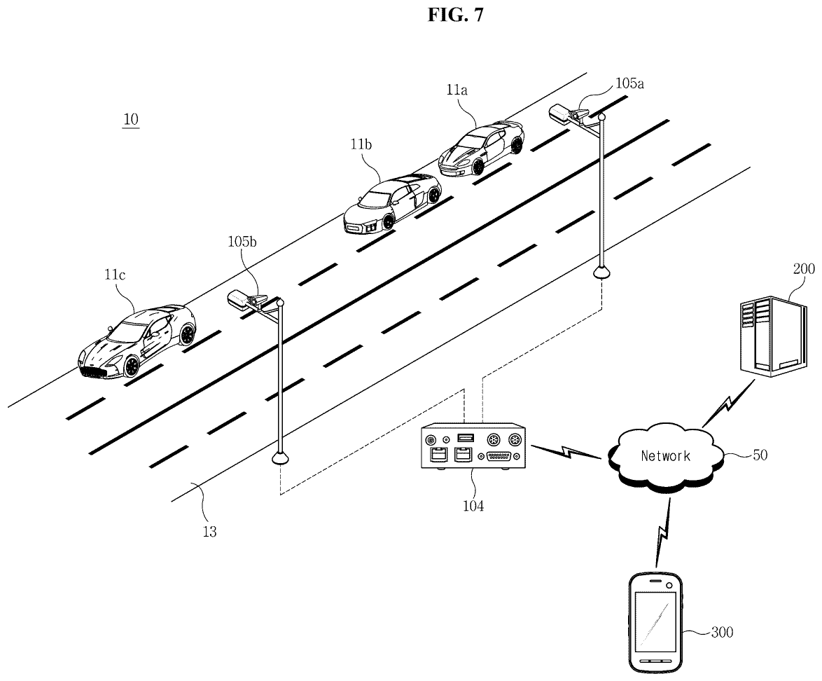

Hereinafter, the second embodiment of the present disclosure will be described with reference to FIGS. 7 to 11.

FIG. 7 is a schematic diagram illustrating an environment for detecting a dangerous driving vehicle according to the second embodiment of the present disclosure.

The environment 10 for detecting (or monitoring) dangerous driving vehicles according to the first embodiment described above (see FIGS. 1 and 4) uses a movable photographing device to obtain images of vehicles 11a, 11b, and 11c driving on the road 13. The movable photographing device may be, for example, a camera-equipped drone 100 (see FIG. 1) or a camera-equipped vehicle 400 (see FIG. 4).

In contrast, the environment 10 for detecting (or monitoring) dangerous driving vehicles according to the second embodiment illustrated in FIG. 7 uses a fixed-type photographing device to obtain images of vehicles 11a, 11b, and 11c driving on the road 13. The fixed-type photographing device may be, for example, CCTV cameras 105a and 105b.

The dangerous driving vehicle detection environment 10 includes a dangerous driving vehicle detection apparatus 200 (which may also be referred to as a monitoring device or a server device), a network 50, and a user terminal 300. In addition, the dangerous driving vehicle detection environment 10 further includes a fixed-type photographing device controller (e.g., a CCTV camera controller 104) connected to the fixed-type photographing device (e.g., the CCTV cameras 105a and 105b).

In this example, the CCTV camera controller 104 is connected to the dangerous driving vehicle detection apparatus 200 via the network 50. In another example, the CCTV camera controller 104 may be implemented as a single electronic device with the driving vehicle detection device 200 without being connected to the driving vehicle detection device 200 via the network 50.

The CCTV cameras 105a and 105b are arranged at regular intervals on the road 13 so that each can obtain CCTV images of a certain area of the road 13. The images obtained by the CCTV cameras 105a and 105b may be, for example, one of an RGB image, a thermal image, and a spectral image. The CCTV cameras 105a and 105b may be arranged around the road 13 so that they can capture images of the road 13 at a certain angle, or may be arranged so as to be spaced upward from the ground of the road 13 by means of a separate structure as illustrated.

The CCTV cameras 105a and 105b may be connected to the CCTV camera controller 104 via a wired cable or wireless connection scheme. The CCTV cameras 105a and 105b can collect CCTV images of the road 13 under the control of the CCTV camera controller 104 and transmit the collected CCTV images to the CCTV camera controller 104. Although two CCTV cameras 105a and 105b are illustrated in the drawing, one or three or more CCTV cameras may be used.

The CCTV camera controller 104 can analyze the CCTV images provided by the CCTV cameras 105a and 105b to determine whether each of the vehicles 11a, 11b, and 11c is driving dangerously. If it is determined that a certain vehicle is driving dangerously, the CCTV camera controller 104 can provide information or a message about the dangerous driving to the vehicle or the driver of the vehicle. Alternatively, the CCTV camera controller 104 may be configured to only perform the role of collecting CCTV images from the CCTV cameras 105a and 105b and providing the collected CCTV images to the dangerous driving vehicle detection apparatus 200. Hereinafter, it will be described that the dangerous driving vehicle detection apparatus 200 analyzes the CCTV images, determines whether the vehicle is driving dangerously based on the analysis results, and processes the analysis results accordingly. However, the present disclosure is not limited to this, and the CCTV camera controller 104 may determine whether a vehicle is being driven dangerously, and provide information on the dangerous driving vehicle to the dangerous driving vehicle detection apparatus 200.

The dangerous driving vehicle detection apparatus 200 of the second embodiment performs substantially the same operation as the dangerous driving vehicle detection apparatus 200 of the first embodiment described above, except that it analyzes CCTV images. Therefore, a detailed description of the dangerous driving vehicle detection apparatus 200 is omitted herein.

In addition, the user terminal 300 of the second embodiment performs substantially the same operation as the user terminal 300 of the first embodiment described above. Therefore, a detailed description of the user terminal 300 is omitted herein.

In addition, the network 50 of the second embodiment performs substantially the same operation as the network 50 of the first embodiment described above, except that it is connected to the CCTV camera controller 104. Therefore, a detailed description of the network 50 is omitted herein.

FIG. 8 is a block diagram illustrating the configuration of a controller for a fixed-type photographing device (e.g., CCTV camera controller) according to the second embodiment of the present disclosure.

Referring to FIG. 8, the CCTV camera controller 104 may include a communication circuit 110, a memory 120, and a controller 150. CCTV cameras 105n may be directly included as a component of the CCTV camera controller 104 or may be connected to the CCTV camera controller 104 as a separate component.

The CCTV cameras 105n are the same as the CCTV cameras 105a and 105b described above in FIG. 7. The CCTV cameras 105n collect CCTV images of the road 13 under the control of the controller 150, and temporarily store the collected CCTV images in the memory 120 or provide them to the controller 150. For example, among the CCTV cameras 105n, the first CCTV camera 105a photographs a designated first area of the road 13 while maintaining a constantly turned-on state, and the second CCTV camera 105b maintains a turned-off state and, upon the control of the controller 150, photographs a designated second area of the road (an area different from the first area). When a plurality of CCTV cameras 105n are arranged at regular intervals on the road 13, a plurality of first CCTV cameras and a plurality of second CCTV cameras may be alternately designated.

The communication circuit 110 may include at least one communication module for establishing a communication channel of the CCTV camera controller 104. For example, the communication circuit 110 may include a first communication module (or a first communication circuit) capable of forming a communication channel with the CCTV cameras 105n, and a second communication module (or a second communication circuit) for a communication connection with the network 50. The first communication module may include a wired communication module, and the second communication module may include a wireless communication module. The first communication module may transmit a CCTV camera control signal to each of the CCTV cameras 105n and receive CCTV images from each of the CCTV cameras 105n. The second communication module may establish a communication channel with the dangerous driving vehicle detection apparatus 200 and transmit CCTV images received from each of the CCTV cameras 105n to the dangerous driving vehicle detection apparatus 200 according to predefined schedule information or in response to the control of the controller 150. Additionally, the second communication module may receive a control signal related to controlling the CCTV cameras 105n from the dangerous driving vehicle detection apparatus 200.

The memory 120 may store data or programs related to the operation of the CCTV camera controller 104. In an example, the memory 120 may receive CCTV images transmitted in real time by at least one of the CCTV cameras 105n and store them temporarily or semi-permanently.

The controller 150 can perform transmission and processing of signals related to the control of the CCTV camera controller 104 and storage or transmission of the processing results. In an example, the controller 150 may generate a control signal for turn-on or turn-off control of the CCTV cameras 105n and transmit the generated control signal to at least one of the CCTV cameras 105n. In addition, the controller 150 may transmit a control signal to at least one of the CCTV cameras 105n to request at least one CCTV image. When the controller 150 receives a CCTV image from at least one of the CCTV cameras 105n, the controller 150 may analyze the received CCTV image to determine whether there is a vehicle that satisfies a predefined dangerous driving condition. If there is a vehicle that satisfies the predefined dangerous driving condition, the controller 150 may provide a control signal including a turn-on and a CCTV image request to the remaining CCTV cameras to receive CCTV images from all the CCTV cameras 105n.

The determination regarding the dangerous driving condition of the vehicle may be performed by the CCTV camera controller 104 or the dangerous driving vehicle detection apparatus 200. In the case that the dangerous driving vehicle detection apparatus 200 performs the determination regarding the dangerous driving condition, the controller 150 may transmit CCTV images provided by some of the CCTV cameras 105n to the dangerous driving vehicle detection apparatus 200 and may receive from the dangerous driving vehicle detection apparatus 200 a control signal for controlling the turn-on and CCTV image collection of the remaining CCTV cameras.

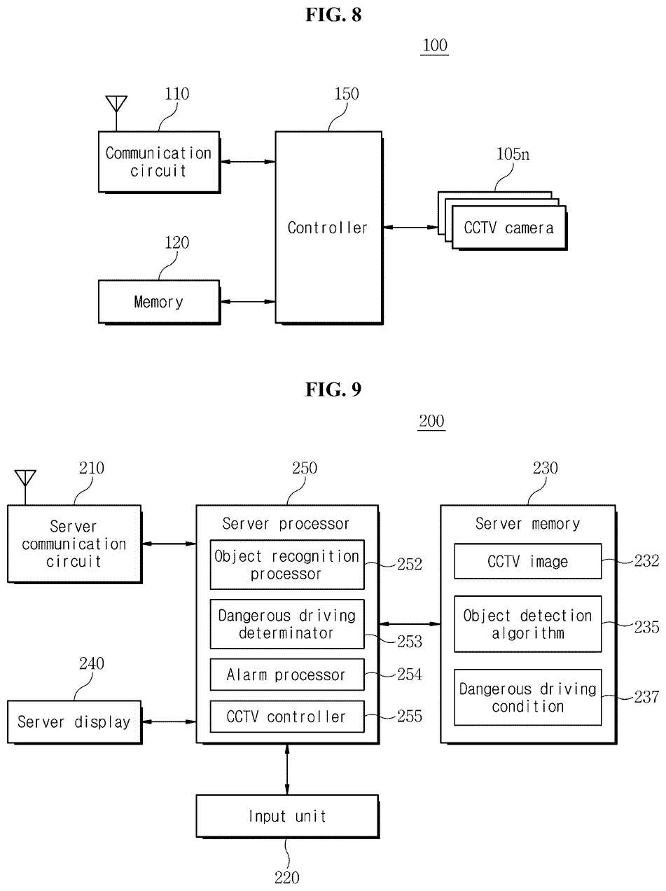

FIG. 9 is a block diagram illustrating the configuration of a dangerous driving vehicle detection apparatus according to the second embodiment of the present disclosure.

The example shown in FIG. 9 is a case where the dangerous driving vehicle detection apparatus 200 is an independent component separated from the CCTV camera controller 104. That is, the example illustrated in FIG. 9 assumes a situation where the CCTV camera controller 104 transmits at least one CCTV image acquired by at least one of the CCTV cameras 105n to the dangerous driving vehicle detection apparatus 200 through the network 50. However, the present disclosure is not limited to this. In another example, the dangerous driving vehicle detection apparatus 200 may be integrated with the CCTV camera controller 104.

Referring to FIG. 9, the dangerous driving vehicle detection apparatus 200 (or referred to as a monitoring device or a server) may include a server communication circuit 210, an input unit 220, a server memory 230, a server display 240, and a server processor 250.

The server communication circuit 210 may support the formation of a communication channel of the dangerous driving vehicle detection apparatus 200. In an example, the server communication circuit 210 may include a first communication circuit capable of forming a communication channel with the CCTV camera controller 104 through the network 50, and a second communication circuit capable of forming a communication channel with the user terminal 300 through the network 50. When the server communication circuit 210 forms a communication channel with the CCTV camera controller 104 and the user terminal 300 through the same type of communication scheme, the server communication circuit 210 may be configured as a single communication circuit. In an example, the server communication circuit 210 may receive a CCTV image from the CCTV camera controller 104 in real time or at regular intervals. Meanwhile, if the CCTV camera controller 104 is designed to determine whether a vehicle is being driven dangerously, the server communication circuit 210 may receive from the CCTV camera controller 104 information on whether a specific vehicle is being driven dangerously and vehicle identification information.

The input unit 220 may include components that support administrator's inputs related to the operation of the dangerous driving vehicle detection apparatus 200. For example, the input unit 220 may include at least one of various input devices such as a keyboard, a keypad, a mouse, a touchscreen, a touchpad, a touch key, a voice input device, a gesture input device, a joystick, and a wheel device. The input unit 220 may generate, in response to administrator's manipulation, at least one input signal from among an input signal requesting a communication connection with the CCTV camera controller 104, an input signal requesting transmission of CCTV images from the CCTV camera controller 104 (this may be omitted if the CCTV camera controller 104 is set to automatically transmit CCTV images), an input signal requesting detection of a dangerous driving vehicle in the received CCTV images, and an input signal indicating a warning when a dangerous driving vehicle exists, and then transmit the generated input signal to the server processor 250.

The server memory 230 may store at least one of data and programs related to the operation of the dangerous driving vehicle detection apparatus 200. For example, the server memory 230 may include at least one CCTV image 232, an object detection algorithm 235, and dangerous driving conditions 237. The CCTV image 232 refers to an image received from the CCTV camera controller 104. For example, the CCTV image 232 may include a CCTV image provided in real time or periodically by at least one of the plurality of CCTV cameras 105n on the road 13. The CCTV image 232 may be an image containing at least one vehicle. The object detection algorithm 235 is an algorithm or program capable of detecting at least one of vehicles object 11a, 11b, and 11c contained in the CCTV image 232. The dangerous driving conditions 237 is a condition to be used for determining that at least one vehicle detected by the object detection algorithm 235 is driving dangerously. In an example, the dangerous driving conditions 237 may include at least one of a speed, a vehicle-to-vehicle distance, the number of lane changes, a sudden stop, a sudden start, and a use of a turn indicator.

The server display 240 may output at least one screen related to the operation of the dangerous driving vehicle detection apparatus 200. For example, the server display 240 may output at least one screen from among a screen indicating a connection status with the CCTV camera controller 104, a screen displaying the CCTV image 232 received in real time from the CCTV camera controller 104, a screen marking at least one vehicle 11a, 11b, and/or 11c detected from the CCTV image 232, a screen marking at least one vehicle 11a, 11b, and/or 11c satisfying the dangerous driving conditions 237, a screen displaying vehicle information of at least one vehicle 11a, 11b, and/or 11c satisfying the dangerous driving conditions 237, and a screen displaying a warning to a vehicle undergoing dangerous driving.

The server processor 250 may perform operations of receiving, transmitting, and processing signals related to the operation of the dangerous driving vehicle detection apparatus 200, and storing or transmitting the processing results. For example, the server processor 250 may receive the CCTV image 232 from the CCTV camera controller 104 based on predefined scheduling information or in response to an administrator's input, detect at least one vehicle object from the received CCTV image 232, and determine whether at least one detected vehicle is driving dangerously. Additionally, the server processor 250 may perform processing for a warning when a dangerously driving vehicle is detected.

Specifically, the server processor 250 may include a CCTV controller 255, an object recognition processor 252, a dangerous driving determinator 253, and an alarm processor 254.

The CCTV controller 255 may generate a control signal related to controlling the CCTV cameras 105n and transmit the generated control signal to the CCTV camera controller 104 via the network 50. In an example, the CCTV controller 255 may generate a control signal related to turning on or turning off the CCTV cameras 105n based on predefined scheduling information or an administrator's input signal. The CCTV controller 255 may provide an interface related to controlling the CCTV cameras 105n to the server display 240 of the dangerous driving detection apparatus 200. In another example, the CCTV controller 255 may control at least one of the CCTV cameras 105n to provide CCTV images, and transmit the received CCTV images to the object recognition processor 252. When the CCTV controller 255 is notified from the object recognition processor 252 that the received CCTV images contain at least one vehicle, the CCTV controller 255 may generate a control signal to turn on all of the CCTV cameras 105n, transmit the generated control signal to the CCTV camera controller 104, and receive CCTV images of all of the CCTV cameras 105n. When the CCTV controller 255 is notified from the object recognition processor 252 that there is no vehicle running on the road 13, the CCTV controller 255 may control the designated CCTV camera among the CCTV cameras 105n to be turned on and the remaining CCTV cameras to be turned off.

The object recognition processor 252 may perform object recognition in the CCTV image 232 received from the CCTV cameras 105n or the CCTV camera controller 104 and stored in the server memory 230 under the control of the CCTV controller 255. In this regard, the object recognition processor 252 may call the object detection algorithm 235 stored in the server memory 230 and use the object detection algorithm 235 to determine whether at least one vehicle is driving in the CCTV image 232. If at least one vehicle is driving, the object recognition processor 252 may detect a vehicle object. The object recognition processor 252 may transmit information about the vehicle object detection to the CCTV controller 255.

In addition, the object recognition processor 252 may create driving information by tracking the movement of the vehicle object based on the CCTV images acquired from the CCTV cameras 105n. Since this has been described above in the first embodiment, a detailed description is omitted herein.

The dangerous driving determinator 253 may receive the driving information from the object recognition processor 252 and, based on the received driving information, determine whether at least one vehicle 11a, 11b, and/or 11c is driving dangerously. Since this has been described above in the first embodiment, a detailed description is omitted herein. Meanwhile, the dangerous driving determinator 253 may determine whether there is a dangerous driving vehicle, by applying an object re-identification method to a plurality of CCTV images to track the travel characteristics (e.g., movement information or driving information) of a vehicle object over a long period of time.

In addition, the dangerous driving determinator 253 may check whether the traffic laws have been updated, and may operate the dangerous driving conditions 237 according to the traffic laws. Since this has been described above in the first embodiment, a detailed description thereof is omitted herein.

The alarm processor 254 may receive information on the occurrence of a vehicle object satisfying the dangerous driving conditions 237 from the dangerous driving determinator 253 and take follow-up measures. Since this has been described above in the first embodiment, a detailed description thereof is omitted herein.

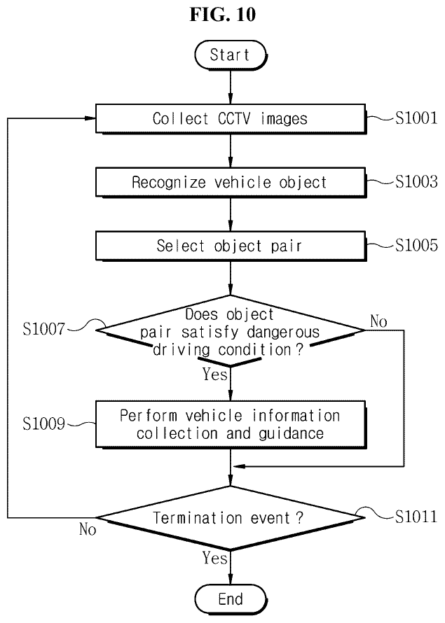

FIG. 10 is a flowchart illustrating one example of a dangerous driving vehicle detection method according to the second embodiment of the present disclosure.

The dangerous driving vehicle detection method shown in FIG. 10 is performed by the server processor (250 in FIG. 9) of the dangerous driving vehicle detection apparatus (200 in FIG. 9) described above.

Referring to FIG. 10, in step S1001, the server processor 250 may perform CCTV image collection. In this case, the server processor 250 may establish a communication channel with the CCTV camera controller 104 and request the CCTV cameras 105n to provide CCTV images collected in real time or periodically.

In step S1003, the server processor 250 may perform vehicle object recognition from the CCTV image. In this step, the server processor 250 may use the object detection algorithm 235 stored in the server memory 230 to determine whether at least one vehicle is contained in the collected CCTV image. In relation to vehicle object recognition, the server processor 250 may remove a background from the CCTV image and determine whether a plurality of vehicles exist.

If a plurality of vehicles exist, the server processor 250 may perform vehicle object pair selection in step S1005. If a plurality of vehicles do not exist, the server processor 250 may return to step 501 and perform the subsequent steps again.

In step S1007, the server processor 250 may check whether the selected vehicle object pair satisfies the dangerous driving condition. Since this is similar to what was described above in step S505 of the first embodiment, a detailed description is omitted herein. However, in the second embodiment, considering the limited shooting range of each of the CCTV cameras 105n and the fast movement of the vehicle, the plurality of CCTV cameras 105n are installed at regular intervals along the direction of travel of the road, and the travel characteristics of the vehicle object are tracked over the long term using an object re-identification method to identify whether there is a dangerous driving vehicle.

If the selected vehicle object pair satisfies the dangerous driving condition, in step S1009, the server processor 250 may perform vehicle information collection and guidance (or warning). Since this is similar to what was described above in step S507 of the first embodiment, a detailed description is omitted herein.

If the dangerous driving condition is not satisfied, the server processor 250 may skip step S1009 and check in step S1011 whether an event related to process termination occurs. If there is no termination event occurrence, the server processor 250 may return to step S1001 and perform subsequent steps again.

If there is a termination event occurrence, the server processor 250 may terminate the process. In an example, if no CCTV image containing the vehicle is received for a predefined time, the server processor 250 may determine that the termination event occurs. Alternatively or additionally, if there is an administrator's input requesting process termination, the server processor 250 may determine that the termination event occurs. When the termination event occurs, the server processor 250 may keep at least one CCTV camera among the plurality of CCTV cameras 105n in a turned-on state and keep the remaining CCTV cameras in a turned-off state. In this case, when receiving a CCTV image containing a vehicle from the CCTV camera in a turned-on state, the server processor 250 may change all the CCTV cameras 105n to a turned-on state and return to step S1001 to perform the subsequent steps again.

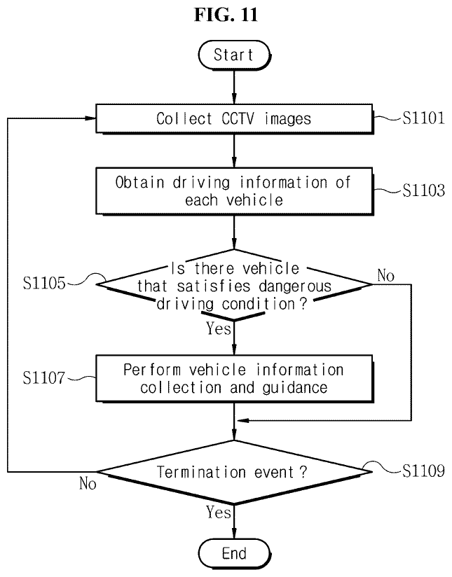

FIG. 11 is a flowchart illustrating another example of a dangerous driving vehicle detection method according to the second embodiment of the present disclosure.

The dangerous driving vehicle detection method shown in FIG. 11 is performed by the server processor (250 in FIG. 9) of the dangerous driving vehicle detection apparatus (200 in FIG. 9) described above.

Referring to FIG. 11, in step S1101, the server processor 250 may perform CCTV image collection. In this regard, the server processor 250 may request and receive the CCTV images from the CCTV camera controller 104 in real time or periodically.

In step S1103, the server processor 250 may obtain driving information for each vehicle contained in the CCTV image. In this regard, the server processor 250 may obtain driving information for at least one vehicle from the CCTV image by using the object detection algorithm 235 stored in the server memory 230. The driving information may include, for example, at least one of lane information, speed information, lane change information, and vehicle-to-vehicle distance information for at least one of the vehicles 11a, 11b, and 11c.

In step S1105, the server processor 250 may detect whether there is a vehicle having driving information satisfying the dangerous driving condition 237. Alternatively, the server processor 250 may check whether the driving information of the vehicle satisfies the dangerous driving condition. In an example, the server processor 250 may check whether the dangerous driving condition is satisfied by checking whether there is a sudden change in speed (e.g., sudden deceleration, sudden slowdown, sudden stop, sudden start) exceeding a predefined reference value among the driving information of the detected vehicle objects, whether a lane change occurs a specified number of times or more within a predefined time, and/or whether a protrusion image is detected from the exterior of at least one vehicle object.

In the case that there is a vehicle satisfying the dangerous driving condition 237, the server processor 250 may perform vehicle information collection and guidance on dangerous driving in step S1107. For example, the server processor 250 may broadcast a warning, provide guidance on imposing a fine, or provide information for guidance to the dangerous driving vehicle through at least one of an audio device and a display device installed on the road 13. Alternatively or additionally, the server processor 250 may provide the user terminal 300 of an administrator managing the road 13 with the location and time of dangerous driving and information on the dangerous driving vehicle.

In the case that there is no vehicle satisfying the dangerous driving condition 237, the server processor 250 may skip step S1107 and check in step S1109 whether an event related to process termination occurs. If there is no termination event occurrence, the server processor 250 may return to step S1101 and perform subsequent steps again. In an example, if no CCTV image containing the vehicle is received for a predefined time, or if there is an administrator's input requesting process termination, the server processor 250 may determine that the termination event occurs. When the termination event occurs, the server processor 250 may keep at least one CCTV camera among the plurality of CCTV cameras 105n in a turned-on state and keep the remaining CCTV cameras in a turned-off state. In this case, when receiving a CCTV image containing a vehicle from the CCTV camera in a turned-on state, the server processor 250 may change all the CCTV cameras 105n to a turned-on state and return to step S1101 to perform the subsequent steps again.

### Third Embodiment

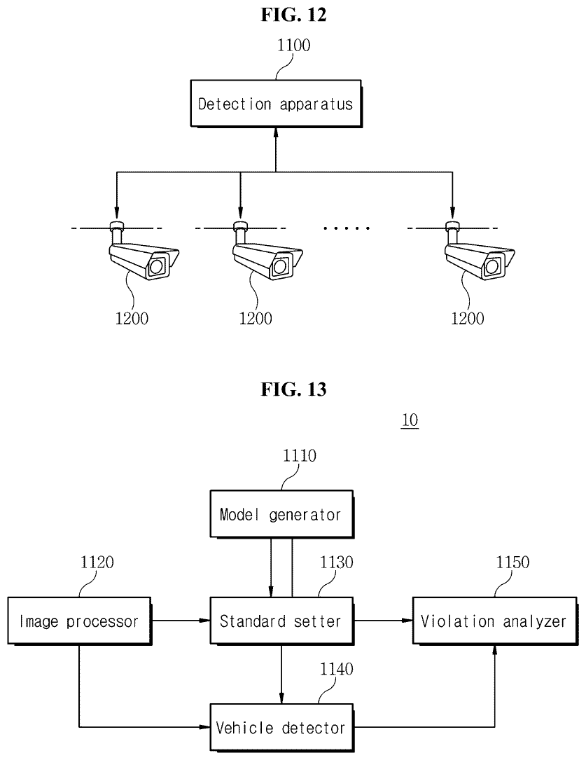

Hereinafter, the third embodiment of the present disclosure will be described with reference to FIGS. 12 to 20.

FIG. 12 is a schematic diagram illustrating a system for detecting a cutting-in vehicle according to the third embodiment of the present disclosure, and FIG. 13 is a block diagram illustrating the configuration of a cutting-in vehicle detection apparatus according to the third embodiment of the present disclosure.

First, referring to FIG. 12, the system according to the third embodiment of the present disclosure includes a detection apparatus 1100 and an imaging device 1200.

The imaging device 1200 is a device including a camera for obtaining streaming images. For example, the imaging device 1200 may be a device that is fixedly installed on one side of a road to detect vehicles the cut in. The imaging device 1200 may include a camera for obtaining streaming images, a transceiver for transmitting images to the detection apparatus 1100, and a microcontroller unit (MCU) for controlling the camera and transceiver.

The detection apparatus 1100 receives a plurality of streaming images from the imaging device 1200 and analyzes the received streaming images to detect vehicles cutting in.

Referring to FIG. 13, the detection apparatus 1100 includes a model generator 1110, an image processor 1120, a standard setter 1130, a vehicle detector 1140, and a violation analyzer 1150.

The model generator 1110 can generate a segmentation model (SM) through learning (e.g., deep learning or machine learning). The segmentation model is learned to detect a mask indicating an area occupied by an object in an image. In this embodiment, the object may be, for example, a vehicle, a road surface marking, etc. When the segmentation model is generated, the model generator 1110 provides the segmentation model to the standard setter 1130 and the vehicle detector 1140.

The segmentation model includes a plurality of layers, and each of the plurality of layers performs a plurality of operations. An operation result of each of a plurality of operation modules on one layer is weighted and then transferred to the next layer. This means that the operation result of the current layer is weighted and input to the operation of the next layer. The segmentation model may be structured with an encoder (EN) and a decoder (DE). The segmentation model having the encoder and the decoder includes a plurality of layers, each of which includes a plurality of operations. In addition, the plurality of layers are connected with weights. The operation result of one layer is weighted and becomes the input of the operation of the next layer. That is, one layer of the segmentation model receives a weighted value from the previous layer, performs an operation on it, and transmits the operation result as the input of the next layer. The encoder includes a plurality of convolution layers (CL) that include a convolution operation and an operation by an activation function. In addition, a pooling layer (PL) that performs a max pooling operation may be applied between the convolution layers of the encoder. When an image (e.g., frame) is input, the encoder performs a plurality of operations in which inter-layer weights are applied to the input image (e.g., frame), thereby compressing (encoding) the input image (e.g., frame) and producing a latent vector. The decoder includes a deconvolution layer (DL) that includes a deconvolution operation and an operation by an activation function. Each decoder receives a latent vector as input, and performs multiple operations in which inter-layer weights are applied to an input latent value (Z), thereby restoring (decoding) the latent vector and deriving a segmented image. The segmented image includes a mask that allows each object contained in the input image (frame) to be distinguished from other objects.

The image processor 1120 is a component for receiving streaming images of a road from the imaging device 1200, extracting frames from the received streaming images, and sequentially providing the frames to the standard setter 1130 or the vehicle detector 1140.

The standard setter 1130 is a component for setting a standard mask (SMSK). The standard setter 1130 detects a mask indicating a road surface marking from a frame in which no mask for another object is detected among multiple frames of the streaming images through the segmentation model. If no mask of another object is included other than the mask indicating the road surface marking, the mask indicating the road surface marking is set as the standard mask (SMSK) and stored.

The vehicle detector 1140 is a component for detecting a vehicle mask indicating a vehicle from the frame of the streaming video through the learned segmentation model.

The violation analyzer 1150 is a component for calculating the degree of overlap between the standard mask and the vehicle mask, and if the degree of overlap is greater than a predetermined value, detecting the vehicle corresponding to the detected vehicle mask as a cutting-in vehicle. If the cutting-in vehicle is detected, the violation analyzer 1150 may provide information (streaming video, etc.) proving the cutting-in to a server of a relevant organization.

The operations of the detection apparatus 1100 that includes the model generator 1110, the image processor 1120, the standard setter 1130, the vehicle detector 1140, and the violation analyzer 1150 will be described in more detail below.

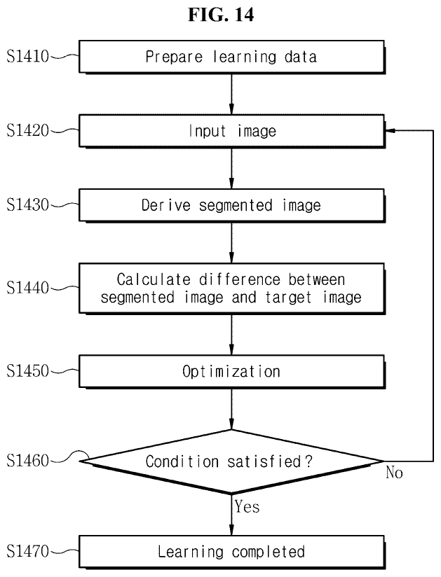

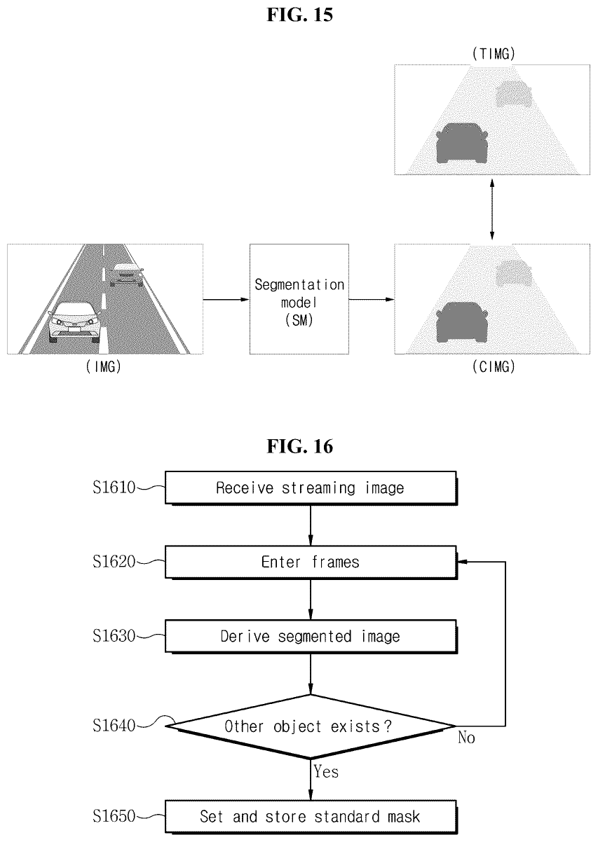

Next, a method for generating the segmentation model will be described. FIG. 14 is a flowchart illustrating a method for generating a segmentation model for cutting-in vehicle detection according to the third embodiment of the present disclosure, and FIG. 15 is a diagram illustrating learning data for generating the segmentation model shown in FIG. 14.

Referring to FIG. 14, the model generator 1110 prepares learning data for training a segmentation model in step S1410. The learning data includes an image (IMG) and a target image (TIMG) corresponding to the image. Here, the image may be one frame of a streaming image. In addition, the image is a photograph of at least one object among a road surface marking and a vehicle. The target image includes a mask in which each object included in the image has a pixel value that distinguishes it from other objects. For example, as illustrated in FIG. 15, it can be seen that the target image is formed of a mask in which the vehicle and road surface marking of the corresponding image have pixel values that distinguish them from each other.

Once the learning data is prepared, in step S1420, the model generator 1110 inputs the image to the segmentation model whose learning has not been completed.

Then, in step S1430, the segmentation model derives a segmented image (SIMG) by performing a plurality of operations in which a plurality of inter-layer weights whose learning has not been completed are applied on the image. The segmented image includes a mask in which respective objects included in the input image are segmented and each object has a pixel value distinguished from the other objects.

Then, in step S1440, the model generator 1110 calculates a loss representing a difference through a loss function between the derived segmented image (SIMG) and the target image (TIMG).

Subsequently, in step S1450, the model generator 1110 performs optimization to modify the weights of the segmentation model so that the loss derived through the loss function is minimized.

The above-described steps S1420 to S1450 are repeatedly performed using different multiple learning data, and the weights of the segmentation model are repeatedly updated according to this repetition. Also, this repetition is performed until the loss converges and becomes below a predetermined target value.

Next, in step S1460, the model generator 1110 checks whether the learning completion condition is satisfied. For example, the model generator 1110 determines whether the loss calculated in step S1440 converges and is below the predetermined target value.

If the learning completion condition is satisfied, the model generator 1110 completes learning for the segmentation model in step S1470.

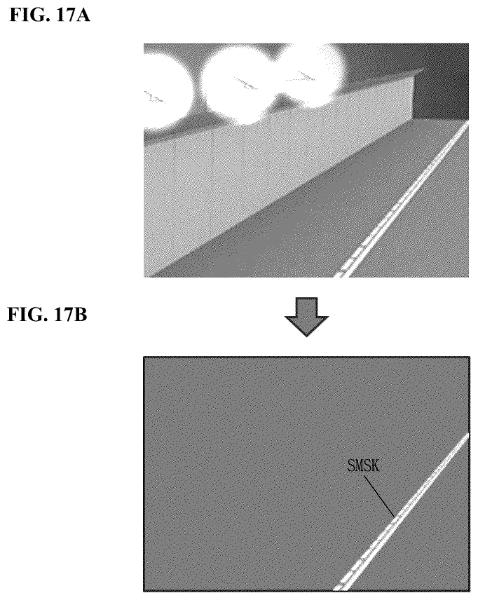

Next, a method for setting a standard mask for cutting-in vehicle detection based on object segmentation. FIG. 16 is a flowchart illustrating a method for setting a standard mask for cutting-in vehicle detection according to the third embodiment of the present disclosure, and FIGS. 17A and 17B are screen examples illustrating the standard mask setting method shown in FIG. 16.

Referring to FIG. 16, in step S1610, the image processor 1120 receives streaming images obtained by capturing an area including a road surface marking from the imaging device 1200.

Then, in step S1620, the image processor 1120 extracts frames from the streaming images and sequentially provides the extracted frames to the standard setter 1130. That is, the image processor 1120 provides the frames extracted from the streaming images to the standard setter 1130 on a frame-by-frame basis.

In step S1630, the standard setter 1130 detects a mask indicating a road surface marking from a frame in which no mask on another object is detected, from among a plurality of frames of the streaming images through the segmentation model previously learned (see FIG. 14). For example, one frame of the streaming image is illustrated in FIG. 17A. When the standard setter 1130 inputs such a frame to the segmentation model, the segmentation model derives a segmented image as shown in FIG. 17B by performing a plurality of operations in which learned weights are applied to pixels included in the frame. The segmented image includes a mask indicating a road surface marking. That is, the segmentation model detects the mask indicating the road surface marking by performing a plurality of operations in which learned weights are applied to pixels included in the frame.

In step S1640, the standard setter 1130 checks whether the segmented image contains a mask of any other object other than the mask indicating the road surface marking.

If there is a mask of an object other than the mask indicating the road surface marking in step S1640, the steps S1620 to S1640 described above are repeated.

On the other hand, if there is no mask of an object other than the mask indicating the road surface marking in step S1640, the standard setter 1130 sets the mask indicating the road surface marking as a standard mask (SMSK) and stores it in step S1650.

For example, if any other object mask other than the mask indicating the road surface marking is not contained in the segmented image as shown in FIG. 17B, the standard setter 1130 sets the mask indicating the road surface marking of the segmented image as the standard mask and stores it. At this time, the standard setter 1130 may set the pixel coordinates of the area occupied by the mask detected in the segmented image as the standard mask and store it.

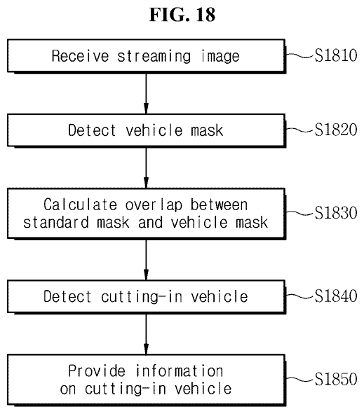

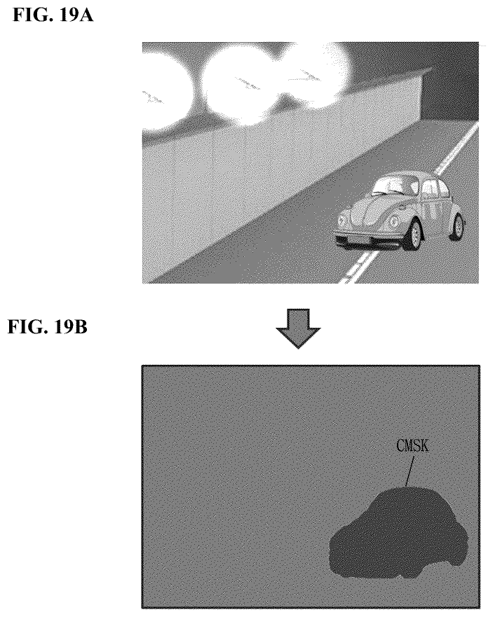

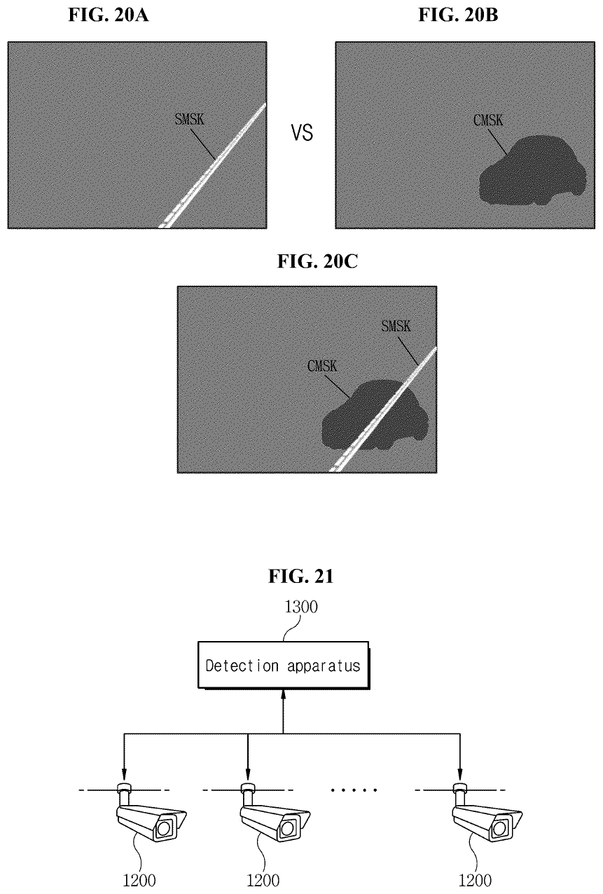

Next, a method for detecting a cutting-in vehicle based on object segmentation using a standard mask and a segmentation model will be described. FIG. 18 is a flowchart illustrating a cutting-in vehicle detection method according to the third embodiment of the present disclosure. FIGS. 19 and 20 are screen examples illustrating the cutting-in vehicle detection method shown in FIG. 18.

Referring to FIG. 18, in step S1810, the image processor 1120 receives streaming images of a road for which a standard mask is set, from the imaging device 1200. Then, the image processor 1120 extracts frames from the received streaming images and provides them sequentially.

Next, in step S1820, the vehicle detector 1140 detects a vehicle mask indicating a vehicle from the frame of the streaming image using the segmentation model learned previously (see FIG. 14). Hereinafter, step S1820 will be described in detail with reference to FIGS. 19A and 19B. The vehicle detector 1140 inputs the frame of the streaming image into the segmentation model as shown in FIG. 19A. Then, the segmentation model derives a segmented image as shown in FIG. 19B by performing a plurality of operations in which learned weights are applied to pixels included in the frame. The segmented image may include a vehicle mask, which is a mask indicating a vehicle in the frame, as shown in FIG. 19B. In other words, the segmentation model detects a vehicle mask indicating a vehicle in the frame by performing a plurality of operations in which learned weights are applied to pixels included in the frame.

Next, in step S1830, the violation analyzer 1150 calculates the degree of overlap between the vehicle mask and the standard mask indicating the road surface marking derived and set previously (see FIG. 16).

At this time, the violation analyzer 1150 calculates the degree of overlap between the pixels of the area occupied by the standard mask (SMSK) and the pixels of the area occupied by the vehicle mask (CMSK) in the frame. For example, when the standard mask (SMSK) is set as shown in FIG. 20A and the vehicle mask (CMSK) is detected as shown in FIG. 20B, the violation analyzer 1150 calculates the degree of overlap between the pixels of the standard mask (SMSK) and the vehicle mask (CMSK) as shown in FIG. 20C.

The violation analyzer 1150 may calculate the degree of overlap between the standard mask (SMSK) and the vehicle mask (CMSK) according to Equation 1 below.

$$O = \frac{2 {\sum }_{i = 0}^{N} ( {s}_{i} + {c}_{i} ) + ε}{{\sum }_{i = 0}^{N} ( {s}_{i}^{2} + {c}_{i}^{2} ) + ε} \qquad [ Equation l ]$$

In Equation 1, ‘O’ denotes the degree of overlap. Also, ‘N’ denotes the number of pixels, and ‘i’ denotes the index of the pixel. In addition, ‘s’ denotes the pixel of the area occupied by the standard mask (SMSK), and ‘c’ denotes the pixel of the area occupied by the vehicle mask (CMSK). Also, ‘ε’ is a hyper-parameter and a preset constant.

Next, in step S1840, if the degree of overlap is greater than a predetermined value, the violation analyzer 1150 detects a vehicle corresponding to the detected vehicle mask as a cutting-in vehicle.

If the cutting-in vehicle is detected, the violation analyzer 1150 provides information (e.g., streaming images, etc.) proving the cutting-in to the server of the relevant organization in step S1850.

### Fourth Embodiment

Hereinafter, the fourth embodiment of the present disclosure will be described with reference to FIGS. 21 to 28.

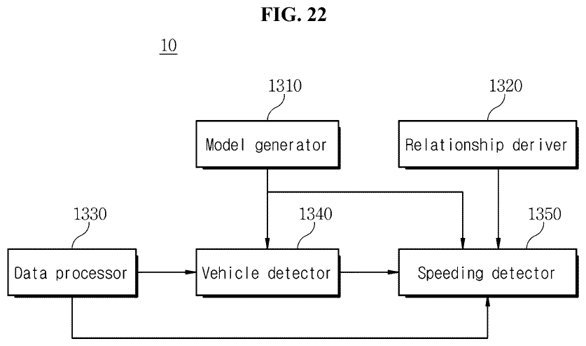

FIG. 21 is a schematic diagram illustrating a system for detecting a cutting-in vehicle according to the fourth embodiment of the present disclosure, and FIG. 22 is a block diagram illustrating the configuration of a cutting-in vehicle detection apparatus according to the fourth embodiment of the present disclosure.

First, referring to FIG. 21, the system according to the fourth embodiment of the present disclosure includes a detection apparatus 1300 and an imaging device 1200.

The imaging device 1200 is substantially the same as the imaging device 1200 (see FIG. 12) described above in the third embodiment, so a detailed description is omitted herein.

The detection apparatus 1300 receives streaming images from the imaging device 1200, analyzes the received streaming images to detect a cutting-in vehicle, and if the cutting-in vehicle is detected, determines whether the cutting-in vehicle is speeding.

Referring to FIG. 22, the detection apparatus 1300 includes a model generator 1310, a relationship deriver 1320, a data processor 1330, a vehicle detector 1340, and a speeding detector 1350.

The model generator 1310 can generate a detection model (DM) through learning (e.g., deep learning or machine learning). The model generator 1310 trains the detection model to detect a bounding box indicating an area occupied by a vehicle in an image. Once the detection model is generated, the model generator 1310 provides the detection model to the vehicle detector 1340 and the speeding detector 1350.

The detection model includes a plurality of layers, and each of the plurality of layers performs a plurality of operations. In one layer, each result of the plurality of operations is weighted and transmitted to the next layer. This means that weights are applied to the operation results of the current layer and input to the operations of the next layer. In other words, the detection model performs a plurality of operations to which the weights of the plurality of layers are applied. The plurality of layers of the detection model include at least one of a fully-connected layer, a convolutional layer, a recurrent layer, a graph layer, and a pooling layer. The plurality of operations may include at least one of a convolution operation, a down sampling operation, an up sampling operation, a pooling operation, and an operation by an activation function. Here, the activation function may include a sigmoid, a hyperbolic tangent (tanh), an exponential linear unit (ELU), a rectified linear unit (ReLU), a leakly ReLU, a Maxout, a Minout, or a Softmax. In an example, the detection model may be R-CNN, R-FCN, FPN-FPCN, YOLO, SDD, RetinaNet, etc. When an image is input, the detection model performs a plurality of operations for applying weights of a plurality of layers to the input image and thereby detects a bounding box representing the area occupied by a vehicle.

The relationship deriver 1320 derives a homography for converting pixel coordinates of the frame of the streaming image into ground-truth coordinates. The frame of the streaming image is captured by a camera of the imaging device 1200 and is composed of a pixel coordinate system. The ground-truth coordinates represent latitude and longitude of a map corresponding to pixels of the image captured by the camera. The relationship deriver 1320 may derive a homography for converting one pixel coordinate (xᵢ, yᵢ) of the frame of the streaming image into the corresponding ground-truth coordinate (x′ᵢ, y′ᵢ). Here, hᵢⱼ (i≤1, j≤3) is a matrix representing the homography, and when the following Equation 2 is satisfied, the relationship deriver 1320 can derive a matrix that minimizes the following Equation 3 as the homography.

$${s}_{i} [ \begin{matrix}{x}_{i}^{′} \\ {y}_{i}^{′} \\ 1\end{matrix} ] ∼ H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ] \qquad [ Equation 2 ]$$

$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2} \qquad [ Equation 3 ]$$

Here, (xᵢ, yᵢ) is a pixel coordinate, and (x′ᵢ, y′ᵢ) represents a ground-truth coordinate.

When the homography is derived, the relationship deriver 1320 provides the derived homography to the speeding detector 1350.

The data processor 1330 continuously receives streaming images of the road captured from the imaging device 1200. The streaming images are composed of multiple frames.

The vehicle detector 1340 detects a cutting-in vehicle by analyzing multiple frames of the streaming images. Specifically, using the detection model, the vehicle detector 1340 detects one or more vehicles through a bounding box in multiple frames of the streaming images. In addition, the vehicle detector 1340 may detect a cutting-in vehicle based on whether a vehicle that is not detected in a first frame among the multiple frames is detected in a second frame that is a later frame than the first frame in time order.

The speeding detector 1350 calculates the speed of the cutting-in vehicle by analyzing a frame in which the cutting-in vehicle is detected among multiple frames, and checks speeding or not based on the calculated speed. Specifically, the speeding detector 1350 selects two frames from among the frames in which the cutting-in vehicle is detected through the bounding box using the detection model, derives a travel distance of the cutting-in vehicle from the two selected frames, and calculates a travel time of the cutting-in vehicle from the number of frames between the two selected frames based on a frame rate of the streaming images. Then, the speeding detector 1350 calculates the speed of the cutting-in vehicle based on the calculated travel distance and travel time. Therefore, based on the calculated speed, the speeding detector 1350 can determine whether or not the cutting-in vehicle is speeding. If the cutting-in vehicle is determined to be speeding, the speeding detector 1350 generates speeding information indicating that the cutting-in vehicle is speeding. The generated speeding information may be provided to a server of a relevant organization. The speeding information may include the speed of the estimated cutting-in vehicle and the frame of the streaming image that contains the cutting-in vehicle.

The operations of the detection apparatus 1300 including the model generator 1310, the relationship deriver 1320, the data processor 1330, the vehicle detector 1340, and the speeding detector 1350 will be described in more detail below.

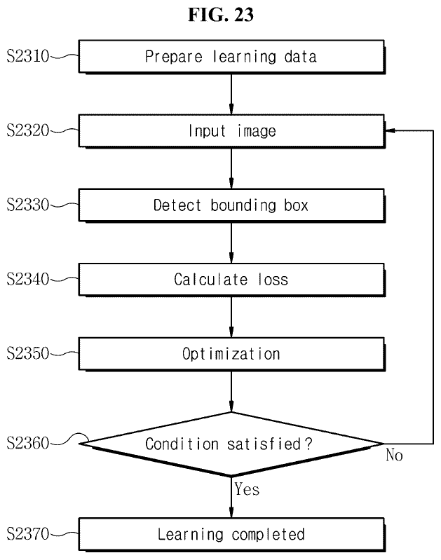

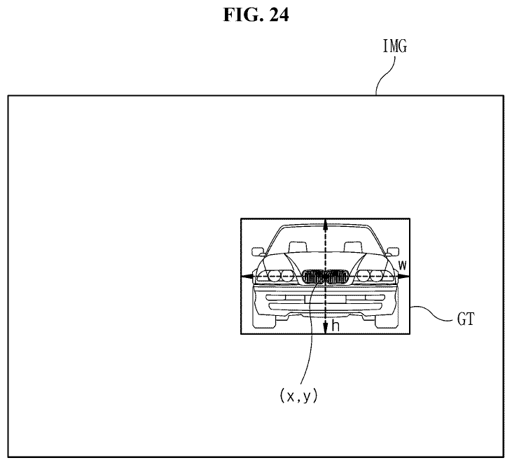

Next, a method for generating the detection model (DM) will be described. FIG. 23 is a flowchart illustrating a method for generating a detection model for cutting-in vehicle detection according to the fourth embodiment of the present disclosure, and FIG. 24 is a diagram illustrating learning data for generating the detection model shown in FIG. 23.

Referring to FIG. 23, in step S2310, the model generator 1310 prepares learning data for training the detection model. The learning data includes an image and a label corresponding to the image. An example of such learning data is illustrated in FIG. 24. Here, an image (IMG) may be one frame of a streaming image. In addition, the image (IMG) is an image obtained by photographing a vehicle. The label is a bounding box indicating an area occupied by the vehicle in the image. The bounding box used as the label is referred to as a ground-truth box (GT) in order to distinguish it from the above-described bounding box detected by the detection model. The ground-truth box (GT) is defined through center coordinates (x, y), width (w), and height (h).

When the learning data is prepared, in step S2320, the model generator 1310 inputs the image into the detection model (DM) whose learning is uncompleted.

Then, in step S2330, the detection model performs a plurality of operations for applying untrained inter-layer weights to the input image, thereby detecting a bounding box that is an area occupied by the vehicle within the image.

In step S2340, the model generator 1310 calculates a loss indicating a difference between the detected bounding box and the ground-truth box (GT) through a loss function.

Then, in step S2350, the model generator 1310 performs optimization to modify the weight of the detection model so that the loss derived through the loss function is minimized.

The above-described steps S2320 to S2350 are repeatedly performed using different multiple learning data, and the weights of the detection model are repeatedly updated according to this repetition. Also, this repetition is performed until the loss converges and becomes below a predetermined target value.

Therefore, in step S2360, the model generator 1310 checks whether the learning completion condition is satisfied. For example, the model generator 1310 determines whether the loss calculated in step S2340 converges and is below the predetermined target value.

If the learning completion condition is satisfied, the model generator 1310 completes learning for the detection model (DM) in step S2370.

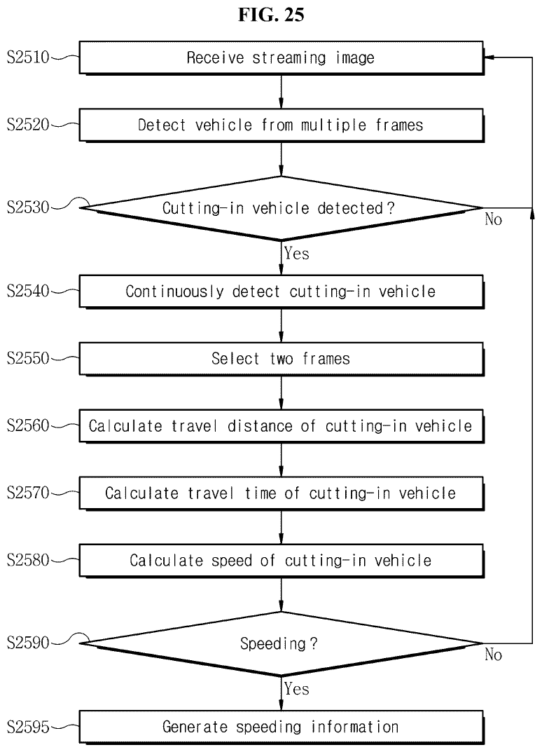

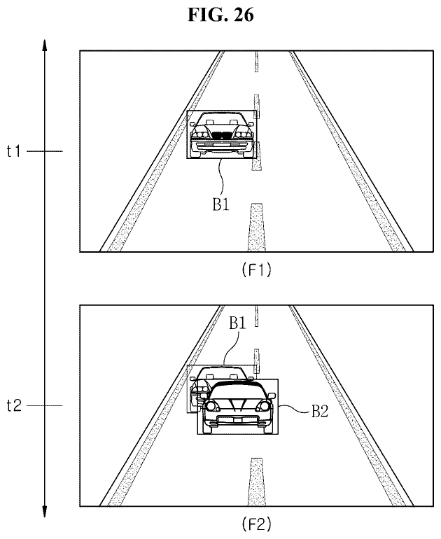

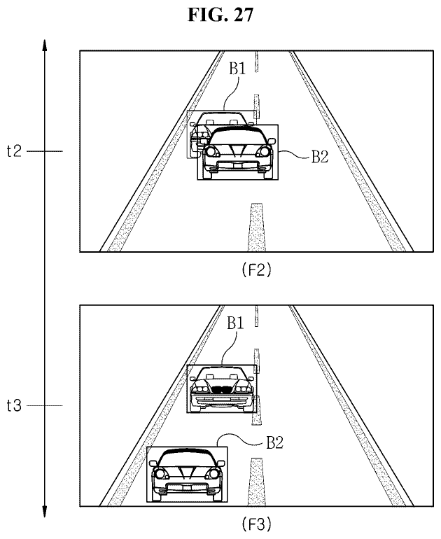

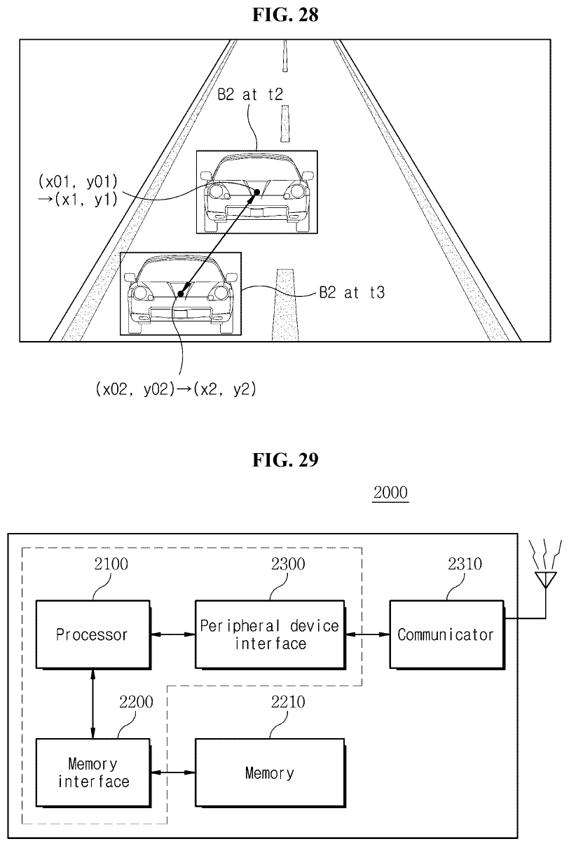

Next, a method for detecting a cutting-in vehicle based on object detection will be described. FIG. 25 is a flowchart illustrating a cutting-in vehicle detection method according to the fourth embodiment of the present disclosure. FIG. 26 is an example screen illustrating the cutting-in vehicle detection method shown in FIG. 25. FIGS. 27 and 28 are example screens illustrating a speed calculation method for cutting-in vehicle detection according to the fourth embodiment of the present disclosure.

Referring to FIG. 25, in step S2510, the data processor 1330 continuously receives streaming images of the road from the imaging device 1200. The streaming images are composed of a plurality of frames, and the plurality of frames include image and audio signals. The data processor 1330 provides the streaming images to the vehicle detector 1340.

In step S2520, the vehicle detector 1340 detects one or more vehicles through the bounding box in the received frames of the streaming images through the detection model (DM).

Then, in step S2530, the vehicle detector 1340 checks whether a cutting-in vehicle is detected. At this time, the vehicle detector 1340 may detect a cutting-in vehicle based on whether a vehicle that is not detected in a first frame among the plurality of frames is detected in a second frame that is a later frame than the first frame in time order.

For example, as illustrated in FIG. 26, the vehicle detector 1340 detects at least one first vehicle driving in a certain lane through a first bounding box B1 in a first frame F1 of a first time point t1 among the plurality of frames. Then, if the first vehicle is detected through the first bounding box B1 in a second frame F2 of a second time point t2 that is later than the first frame F1 in time sequence, and if a second vehicle located in front of the first vehicle is detected through a second bounding box (B2), the vehicle detector 1340 recognizes the detected second vehicle as a cutting-in vehicle.

If a cutting-in vehicle is not detected in step S2530, steps S2510 to S2530 described above are repeated. On the other hand, if a cutting-in vehicle is detected in step S2530, the process proceeds to step S2540.

In step S2540, the speeding detector 1350 continuously detects the cutting-in vehicle through the bounding box from the multiple frames using the detection model.

Also, in step S2550, the speeding detector 1350 selects two different frames from among the frames in which the cutting-in vehicle is detected. For example, as illustrated in FIG. 27, it is assumed that after the speeding detector 1350 detects the cutting-in vehicle through the second bounding box B2 in the second frame F2 of the second time point t2 among the multiple frames, the second vehicle is also detected through the second bounding box B2 in a third frame F3 of a third time point t3 that is later than the second frame F2 in time sequence. In this case, the second frame F2 and the third frame F3 may be selected. Additionally, if there is any intermediate frame between the second frame F2 and the third frame F3, and the cutting-in vehicle is detected through the bounding box of this intermediate frame, this frame may be selected instead of one of the second frame F2 and the third frame F3.

Next, in step S2560, the speeding detector 1350 calculates a travel distance of the cutting-in vehicle from a distance between the bounding boxes of the cutting-in vehicle in the two previously selected frames. This step S2560 is described in detail hereinafter.

First, using the previously calculated homography, the speeding detector 1350 converts the pixel coordinates of the center of the bounding box of each of the two frames selected in step S2550 into ground-truth coordinates. For example, referring to FIGS. 27 and 28, if one of the two selected frames is the second frame F2 of the second time point t2 and the other is the third frame F3 of the third time point t3, the speeding detector 1350 converts the center coordinates (x01, y01) of the second bounding box B2 in the second frame F2 of the second time point t2 into the ground-truth coordinates (x1, y1) through homography, and also converts the center coordinates (x02, y02) of the second bounding box B2 in the third frame F3 of the third time point t3 into the ground-truth coordinates (x2, y2) through homography.

After obtaining the converted ground-truth coordinates, the speeding detector 1350 calculates the travel distance of the cutting-in vehicle from a distance between the converted ground-truth coordinates. That is, the speeding detector 1350 may calculate the travel distance of the vehicle according to Equation 4 below.

$$D = \sqrt{{( {x}_{2} - {x}_{1} )}^{2} - {( {y}_{2} - {y}_{1} )}^{2}} \qquad [ Equation 4 ]$$

In Equation 4, ‘D’ denotes the travel distance of the cutting-in vehicle. In addition, ‘x1’ and ‘y1’ are the ground-truth coordinates converted from the pixel coordinates of the center of the bounding box of the first frame among the selected frames. Also, ‘x2’ and ‘y2’ are the ground-truth coordinates converted from the pixel coordinates of the center of the bounding box of the second frame among the selected frames.

In step S2570, the speeding detector 1350 calculates a travel time of the cutting-in vehicle from the number of frames between two selected frames according to the frame rate of the streaming images. For example, if the frame rate of the streaming images is 18 fps and the number of frames between two selected frames is 90, the travel time becomes 5 seconds.

In step S2580, the speeding detector 1350 calculates the speed of the cutting-in vehicle based on the travel distance and travel time calculated in steps S2560 and S2570, respectively.

Next, in step S2590, the speeding detector 1350 determines whether there is speeding, based on the calculated speed.

If it is determined in step S2590 that there is speeding, the speeding detector 1350 generates speeding information indicating that the cutting-in vehicle is speeding in step S2595. The generated speeding information may be provided to a server of a relevant organization. The speeding information includes the speed of the estimated cutting-in vehicle and a frame of the streaming image that contains the cutting-in vehicle.

FIG. 29 is an example diagram illustrating a hardware system for implementing the apparatus according to the first to fourth embodiments of the present disclosure.

Specifically, the hardware system 2000 illustrated in FIG. 29 may be used to implement the dangerous driving vehicle detection apparatus 200 (see FIG. 3) according to the first embodiment, the dangerous driving vehicle detection apparatus 200 (see FIG. 9) according to the second embodiment, the cutting-in vehicle detection apparatus 1100 (see FIG. 13) according to the third embodiment, and the cutting-in vehicle detection apparatus 1300 (see FIG. 22) according to the fourth embodiment, respectively.

As shown in FIG. 29, the hardware system 2000 may include a processor 2100, a memory interface 2200, and a peripheral device interface 2300.

These respective elements in the hardware system 2000 may be individual components or be integrated into one or more integrated circuits and may be connected by a bus system (not shown).

Here, the bus system is an abstraction that represents any one or more separate physical buses, communication lines/interfaces, and/or multi-drop or point-to-point connections, connected by appropriate bridges, adapters, and/or controllers.

The processor 2100 serves to execute various software modules stored in the memory 2210 by communicating with the memory 2210 through the memory interface 2200 in order to perform various functions in the hardware system.

In the memory 2210, components such as the drone controller 251, object recognition processor 252, dangerous driving determinator 253, and alarm processor 254 described above in FIG. 3, the CCTV controller 255, object recognition processor 252, dangerous driving determinator 253, and alarm processor 254 described above in FIG. 9, the model generator 1110, image processor 1120, standard setter 1130, vehicle detector 1140, and violation analyzer 1150 described above in FIG. 13, and the model generator 1310, relationship deriver 1320, data processor 1330, vehicle detector 1340, and speeding detector 1350 described above in FIG. 22 may be stored in the form of software modules, and the operating system (OS) may be further stored. These components may be loaded into and executed by the processor 2100.

In addition, the above-mentioned components may be implemented in the form of a software module or hardware module executed by the processor 2100, or may also be implemented in the form of a combination of a software module and a hardware module. As such, the software module, the hardware module, or the combination thereof executed by the processor may be implemented as an actual hardware system (e.g., a computer system).

The operating system (e.g., embedded operating system such as I-OS, Android, Darwin, RTXC, LINUX, UNIX, OS X, WINDOWS, or VxWorks) includes various procedures, command sets, software components and/or drivers that control and manage general system tasks (e.g., memory management, storage device control, power management, etc.) and plays a role in facilitating communication between various hardware modules and software modules.

The memory 2210 may include a memory hierarchy including, but not limited to, a cache, a main memory, and a secondary memory. The memory hierarchy may be implemented via, for example, any combination of RAM (e.g., SRAM, DRAM, DDRAM), ROM, FLASH, magnetic and/or optical storage devices (e.g., disk drive, magnetic tape, compact disk (CD), digital video disc (DVD)).

The peripheral device interface 2300 serves to enable communication between the processor 2100 and peripheral devices. The peripheral devices are to provide different functions to the hardware system 2000, and may include a communicator 2310 for example.

The communicator 2310 serves to provide a communication function with other devices. For this purpose, the communicator 2310 may include, for example, but not limited to, an antenna system, an RF transceiver, one or more amplifiers, a tuner, one or more oscillators, and a digital signal processor, a CODEC chipset, and a memory, and may also include a known circuit that performs this function.

The communicator 2310 may support communication protocols such as, for example, WLAN (Wireless LAN), DLNA (Digital Living Network Alliance), Wibro (Wireless Broadband), Wimax (World Interoperability for Microwave Access), GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), IEEE 802.16, LTE (Long Term Evolution), LTE-A (Long Term Evolution-Advanced), 5G communication system, WMBS (Wireless Mobile Broadband Service), Bluetooth, RFID (Radio Frequency Identification), IrDA (Infrared Data Association), UWB (Ultra-Wideband), ZigBee, NFC (Near Field Communication), USC (Ultra Sound Communication), VLC (Visible Light Communication), Wi-Fi, Wi-Fi Direct, and the like. In addition, as wired communication networks, wired LAN (Local Area Network), wired WAN (Wide Area Network), PLC (Power Line Communication), USB communication, Ethernet, serial communication, optical/coaxial cables, etc. may be included. This is not a limitation, and any protocol capable of providing a communication environment with other devices may be included.

In the hardware system 2000 according to the present disclosure, each components stored in the memory 2210 in the form of a software module performs an interface with the communicator 2310 via the memory interface 2200 and the peripheral device interface 2300 in the form of a command executed by the processor 2100.

While the description contains many specific implementation details, these should not be construed as limitations on the scope of the present disclosure or of what may be claimed, but rather as descriptions of features that may be specific to particular embodiments of particular disclosure.

Also, although the description describes that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

The description shows the best mode of the present disclosure and provides examples to illustrate the present disclosure and to enable a person skilled in the art to make and use the present disclosure. The present disclosure is not limited by the specific terms used herein. Based on the above-described embodiments, one of ordinary skill in the art can modify, alter, or change the embodiments without departing from the scope of the present disclosure.

Accordingly, the scope of the present disclosure should not be limited by the described embodiments and should be defined by the appended claims.

What is claimed is:

1. An apparatus for detecting a dangerous driving vehicle, the apparatus comprising:
a server communication circuit; and
a server processor functionally connected to the server communication circuit,
the server processor configured to:
provide coordinate information for a specific area of a road to a movable photographing device,
receive a photographed image for the specific area of the road corresponding to the coordinate information from the movable photographing device,
detect at least one vehicle object from the photographed image,
detect driving information of the detected at least one vehicle object,
check whether the driving information satisfies a predefined dangerous driving condition, and
if the dangerous driving condition is satisfied, determine a vehicle corresponding to the driving information as a dangerous driving vehicle.

2. The apparatus of claim 1, wherein the server processor is configured to:
identify a location of the specific area of the road,
determine a type of movable photographing device based on the identified location, and
provide the coordinate information to the determined type of movable photographing device.

3. The apparatus of claim 1, wherein the server processor is configured to:
collect vehicle information on the dangerous driving vehicle, and
provide the vehicle information and a warning message about the dangerous driving vehicle to the movable photographing device so that the movable photographing device outputs the warning message toward the dangerous driving vehicle through an audio device of the movable photographing device.

4. The apparatus of claim 1, wherein the server processor is configured to:
detect driving information of the at least one vehicle object,
obtain the driving information of the at least one vehicle object again after a given time, and
compare the obtained driving information with the detected driving information so as to determine the vehicle with the driving information as the dangerous driving vehicle when dangerous driving continues for the given time.

5. The apparatus of claim 1, wherein the server processor is configured to:
track a vehicle-to-vehicle distance, and
if the vehicle-to-vehicle distance is within a predefined range or is gradually reduced and then maintained for a predefined period of time or longer, determine at least one vehicle object in a vehicle object pair corresponding to the vehicle-to-vehicle distance as the dangerous driving vehicle.

6. The apparatus of claim 1, wherein the server processor is configured to:
when a plurality of vehicle objects satisfying the dangerous driving condition are detected, determine, as the dangerous driving vehicle, a vehicle object having a greater speed change, a vehicle object having a speed change greater than a predefined reference value, or a vehicle object having a lane change greater than a predefined number of times within a predefined period of time.

7. A method for detecting a dangerous driving vehicle, performed by a server processor of a dangerous driving vehicle detection apparatus, the method comprising:
providing coordinate information for a specific area of a road to a movable photographing device;
receiving a photographed image for the specific area of the road corresponding to the coordinate information from the movable photographing device;
detecting at least one vehicle object from the photographed image;
detecting driving information of the detected at least one vehicle object;
checking whether the driving information satisfies a predefined dangerous driving condition; and
if the dangerous driving condition is satisfied, determining a vehicle corresponding to the driving information as a dangerous driving vehicle.

8. The method of claim 7, further comprising:
identifying a location of the specific area of the road;
determining a type of movable photographing device based on the identified location; and
providing the coordinate information to the determined type of movable photographing device.

9. The method of claim 7, further comprising:
collecting vehicle information on the dangerous driving vehicle; and
providing the vehicle information and a warning message about the dangerous driving vehicle to the movable photographing device so that the movable photographing device outputs the warning message toward the dangerous driving vehicle through an audio device of the movable photographing device.

10. The method of claim 7, wherein determining a vehicle as a dangerous driving vehicle includes:
detecting driving information of the at least one vehicle object;
obtaining the driving information of the at least one vehicle object again after a given time; and
comparing the obtained driving information with the detected driving information so as to determine the vehicle with the driving information as the dangerous driving vehicle when dangerous driving continues for the given time.

11. The method of claim 7, wherein determining a vehicle as a dangerous driving vehicle includes:
tracking a vehicle-to-vehicle distance; and
if the vehicle-to-vehicle distance is within a predefined range or is gradually reduced and then maintained for a predefined period of time or longer, determining at least one vehicle object in a vehicle object pair corresponding to the vehicle-to-vehicle distance as the dangerous driving vehicle.

12. The method of claim 7, wherein determining a vehicle as a dangerous driving vehicle includes:
when a plurality of vehicle objects satisfying the dangerous driving condition are detected, determining, as the dangerous driving vehicle, a vehicle object having a greater speed change, a vehicle object having a speed change greater than a predefined reference value, or a vehicle object having a lane change greater than a predefined number of times within a predefined period of time.

13. An apparatus for detecting a dangerous driving vehicle, the apparatus comprising:
a server communication circuit; and
a server processor functionally connected to the server communication circuit,
the server processor configured to:
receive a CCTV image of a road,
detect a pair of vehicle objects in the CCTV image,
check whether a movement of the pair of vehicle objects satisfies a predefined dangerous driving condition, and
determine a vehicle having the movement satisfying the dangerous driving condition as a dangerous driving vehicle.

14. The apparatus of claim 13, wherein the server processor is configured to:
track a change in a vehicle-to-vehicle distance of the vehicle object pair, and
if the vehicle-to-vehicle distance change is within a predefined range or is gradually reduced and then maintained for a predefined period of time, determine at least one vehicle object in the vehicle object pair as the dangerous driving vehicle.

15. The apparatus of claim 14, wherein the server processor is configured to:
determine, as the dangerous driving vehicle, a vehicle object having a greater speed change in the vehicle object pair.

16. The apparatus of claim 14, wherein the server processor is configured to:
determine, as the dangerous driving vehicle, a vehicle object having a speed change greater than a predefined reference value in the vehicle object pair.

17. The apparatus of claim 14, wherein the server processor is configured to:
determine, as the dangerous driving vehicle, a vehicle object having a lane change greater than a predefined number of times within a predefined period of time in the vehicle object pair.

18. The apparatus of claim 13, wherein the server processor is configured to:
transmit information on the dangerous driving vehicle to a user terminal of an administrator managing the road, or
collect vehicle information on the dangerous vehicle object and transmit a warning for dangerous driving to a user terminal corresponding to the vehicle information.

19. A method for detecting a dangerous driving vehicle, performed by a server processor of a dangerous driving vehicle detection apparatus, the method comprising:
receiving a CCTV image of a road;
detecting a pair of vehicle objects in the CCTV image;
checking whether a movement of the pair of vehicle objects satisfies a predefined dangerous driving condition; and
determining a vehicle having the movement satisfying the dangerous driving condition as a dangerous driving vehicle.

20. The method of claim 19, wherein determining a vehicle as a dangerous driving vehicle includes:
tracking a change in a vehicle-to-vehicle distance of the vehicle object pair; and
if the vehicle-to-vehicle distance change is within a predefined range or is gradually reduced and then maintained for a predefined period of time, determining at least one vehicle object in the vehicle object pair as the dangerous driving vehicle.

21. The method of claim 20, wherein determining a vehicle as a dangerous driving vehicle includes:
determining, as the dangerous driving vehicle, a vehicle object having a greater speed change in the vehicle object pair.

22. The method of claim 20, wherein determining a vehicle as a dangerous driving vehicle includes:
determining, as the dangerous driving vehicle, a vehicle object having a speed change greater than a predefined reference value in the vehicle object pair.

23. The method of claim 20, wherein determining a vehicle as a dangerous driving vehicle includes:
determining, as the dangerous driving vehicle, a vehicle object having a lane change greater than a predefined number of times within a predefined period of time in the vehicle object pair.

24. The method of claim 19, further comprising:
transmitting information on the dangerous driving vehicle to a user terminal of an administrator managing the road; or
collecting vehicle information on the dangerous vehicle object and transmitting a warning for dangerous driving to a user terminal corresponding to the vehicle information.

25. A method for detecting a cutting-in vehicle, the method comprising:
by an image processor, receiving a streaming image of a road from an imaging device;
by a vehicle detector, detecting a vehicle mask representing a vehicle from a frame of the streaming image through a segmentation model;
by a violation analyzer, calculating a degree of overlap between the vehicle mask and a standard mask representing a predetermined road surface marking on the road; and
by the violation analyzer, detecting a vehicle corresponding to the detected vehicle mask as a cutting-in vehicle if the degree of overlap is greater than a predetermined value.

26. The method of claim 25, wherein calculating a degree of overlap includes:
by the violation analyzer, calculating the degree of overlap between pixels of an area occupied by the standard mask and pixels of an area occupied by the vehicle mask in the frame.

27. The method of claim 25, wherein calculating a degree of overlap includes:
by the violation analyzer, calculating the degree of overlap according to Equation,
$$O = \frac{2 {\sum }_{i = 0}^{N} ( {s}_{i} + {c}_{i} ) + ε}{{\sum }_{i = 0}^{N} ( {s}_{i}^{2} + {c}_{i}^{2} ) + ε}$$
where ‘O’ denotes the degree of overlap, ‘N’ denotes a number of pixels, ‘i’ denotes an index of a pixel, ‘s’ denotes a pixel of an area occupied by the standard mask, ‘c’ denotes a pixel of an area occupied by the vehicle mask, and ‘ε’ is a hyper-parameter.

28. The method of claim 25, wherein detecting a vehicle mask includes:
by the vehicle detector, inputting the frame to the segmentation model; and
by the segmentation model, detecting the vehicle mask representing the vehicle in the frame by performing a plurality of operations for applying trained weights to pixels included in the frame.

29. The method of claim 25, further comprising:
before receiving the streaming image of the road,
by the image processor, upon receiving streaming images obtained by capturing an area including a road surface marking from the imaging device, extracting a plurality of frames from the streaming images and sequentially providing the extracted frames;
by a standard setter, deriving a segmented image including a mask indicating the road surface marking from a frame in which no mask for other object is detected among the extracted frames through a segmentation model;
by the standard setter, checking whether the segmented image includes a mask of other object other than the mask indicating the road surface marking; and
by the standard setter, if no mask of other object other than the mask indicating the road surface marking is included, setting the mask indicating the road surface marking as a standard mask.

30. The method of claim 29, wherein setting the mask as a standard mask includes:
by the standard setter, setting pixel coordinates of an area occupied by the detected mask as the standard mask.

31. The method of claim 25, further comprising:
before receiving the streaming image of the road,
by a model generator, preparing learning data including an image and a target image, the image containing at least one object among a road surface marking and a vehicle, and the target image containing a mask having pixel values that distinguish each object contained in the image from other objects;
by the model generator, inputting the image to a segmentation model whose learning is uncompleted;
by the segmentation model, segmenting the objects contained in the image through a plurality of operations for applying untrained weights to the image, thereby deriving a segmented image containing a mask having pixel values that distinguish each object from other objects;
by the model generator, calculating a loss representing a difference between the segmented image and the target image; and
by the model generator, performing optimization to modify the weights of the segmentation model so that the loss is minimized.

32. An apparatus for detecting a cutting-in vehicle, the apparatus comprising:
an image processor configured to receive a streaming image of a road from an imaging device;
a vehicle detector configured to detect a vehicle mask representing a vehicle from a frame of the streaming image through a segmentation model; and
a violation analyzer configured to calculate a degree of overlap between the vehicle mask and a standard mask representing a predetermined road surface marking on the road, and to detect a vehicle corresponding to the detected vehicle mask as a cutting-in vehicle if the degree of overlap is greater than a predetermined value.

33. The apparatus of claim 32, wherein the violation analyzer is configured to:
calculate the degree of overlap between pixels of an area occupied by the standard mask and pixels of an area occupied by the vehicle mask in the frame.

34. The apparatus of claim 32, wherein the violation analyzer is configured to:
calculate the degree of overlap according to Equation,
$$O = \frac{2 {\sum }_{i = 0}^{N} ( {s}_{i} + {c}_{i} ) + ε}{{\sum }_{i = 0}^{N} ( {s}_{i}^{2} + {c}_{i}^{2} ) + ε}$$
where ‘O’ denotes the degree of overlap, ‘N’ denotes a number of pixels, ‘i’ denotes an index of a pixel, ‘s’ denotes a pixel of an area occupied by the standard mask, ‘c’ denotes a pixel of an area occupied by the vehicle mask, and ‘ε’ is a hyper-parameter.

35. The apparatus of claim 32, wherein the vehicle detector is configured to input the frame to the segmentation model, and
the segmentation model is configured to detect the vehicle mask representing the vehicle in the frame by performing a plurality of operations for applying trained weights to pixels included in the frame.

36. The apparatus of claim 32, wherein the image processor is configured to:
upon receiving streaming images obtained by capturing an area including a road surface marking from the imaging device, extract a plurality of frames from the streaming images and sequentially providing the extracted frames, and
the apparatus further comprises:
a standard setter configured to:
derive a segmented image including a mask indicating the road surface marking from a frame in which no mask for other object is detected among the extracted frames through a segmentation model,
check whether the segmented image includes a mask of other object other than the mask indicating the road surface marking, and
if no mask of other object other than the mask indicating the road surface marking is included, set the mask indicating the road surface marking as a standard mask.

37. The apparatus of claim 36, wherein the standard setter is configured to:
set pixel coordinates of an area occupied by the detected mask as the standard mask.

38. The apparatus of claim 32, further comprising:
a model generator configured to:
prepare learning data including an image and a target image, the image containing at least one object among a road surface marking and a vehicle, and the target image containing a mask having pixel values that distinguish each object contained in the image from other objects,
input the image to a segmentation model whose learning is uncompleted,
when the segmentation model segments the objects contained in the image through a plurality of operations for applying untrained weights to the image, and thereby derives a segmented image containing a mask having pixel values that distinguish each object from other objects,
calculate a loss representing a difference between the segmented image and the target image, and
perform optimization to modify the weights of the segmentation model so that the loss is minimized.

39. A method for detecting a cutting-in vehicle, the method comprising:
by a data processor, receiving streaming images of a road from an imaging device;
by a vehicle detector, detecting one or more vehicles through a bounding box in a plurality of frames of the streaming images using a detection model; and
by the vehicle detector, detecting a cutting-in vehicle based on whether a vehicle not detected in a first frame among the plurality of frames is detected in a second frame subsequent to the first frame.

40. The method of claim 39, wherein detecting a cutting-in vehicle includes:
by the vehicle detector, detecting at least one first vehicle driving in one lane in a first frame among the plurality of frames;
by the vehicle detector, checking whether a second vehicle located in front of the first vehicle is detected in a second frame subsequent to the first frame; and
by the vehicle detector, if the second vehicle is detected, recognizing the detected second vehicle as the cutting-in vehicle.

41. The method of claim 39, further comprising:
by a speeding detector, when the cutting-in vehicle is detected, continuously detecting the cutting-in vehicle through a bounding box in a plurality of frames using the detection model;
by the speeding detector, selecting two different frames from among frames in which the cutting-in vehicle is detected;
by the speeding detector, calculating a travel distance of the cutting-in vehicle from a distance between the bounding boxes of the cutting-in vehicle in the selected two frames;
by the speeding detector, calculating a travel time of the cutting-in vehicle by applying a frame rate of the streaming images to a number of the frames in which the cutting-in vehicle is detected;
by the speeding detector, calculating a speed of the cutting-in vehicle based on the travel distance and the travel time; and
by the speeding detector, determining whether the cutting-in vehicle is speeding based on the calculated speed.

42. The method of claim 41, wherein calculating a travel distance of the cutting-in vehicle includes:
by the speeding detector, converting pixel coordinates of a center of a bounding box of each of the selected two frames into ground-truth coordinates using a homography; and
by the speeding detector, calculating the travel distance of the cutting-in vehicle from a distance of the ground-truth coordinates.

43. The method of claim 41, wherein calculating a travel distance of the cutting-in vehicle includes:
by the speeding detector, calculating the travel distance of the cutting-in vehicle according to Equation,
$$D = \sqrt{{( {x}_{2} - {x}_{1} )}^{2} - {( {y}_{2} - {y}_{1} )}^{2}}$$
where ‘D’ denotes the travel distance of the cutting-in vehicle, ‘x1’ and ‘y1’ are the ground-truth coordinates converted from the pixel coordinates of the center of the bounding box of the first frame among the selected frames, and ‘x2’ and ‘y2’ are the ground-truth coordinates converted from the pixel coordinates of the center of the bounding box of the second frame among the selected frames.

44. The method of claim 39, further comprising:
before receiving the streaming images,
by a model generator, preparing learning data including an image and a label, the image containing a vehicle, and the label containing a ground-truth box indicating an area occupied by the vehicle in the image;
by the model generator, inputting the image into a detection model whose learning is uncompleted;
by the detection model, detecting a bounding box representing an area occupied by the vehicle in the image through a plurality of operations for applying untrained weights to the image;
by the model generator, calculating a loss representing a difference between the detected bounding box and the ground-truth box of the label; and
by the model generator, performing optimization by modifying the weights of the detection model so that the loss is minimized.

45. An apparatus for detecting a cutting-in vehicle, the apparatus comprising:
a data processor configured to receive streaming images of a road from an imaging device; and
a vehicle detector configured to detect one or more vehicles through a bounding box in a plurality of frames of the streaming images using a detection model, and to detect a cutting-in vehicle based on whether a vehicle not detected in a first frame among the plurality of frames is detected in a second frame subsequent to the first frame.

46. The apparatus of claim 45, wherein the vehicle detector is configured to:
detect at least one first vehicle driving in one lane in a first frame among the plurality of frames,
check whether a second vehicle located in front of the first vehicle is detected in a second frame subsequent to the first frame, and
if the second vehicle is detected, recognize the detected second vehicle as the cutting-in vehicle.

47. The apparatus of claim 45, further comprising:
a speeding detector configured to:
when the cutting-in vehicle is detected, continuously detect the cutting-in vehicle through a bounding box in a plurality of frames using the detection model,
select two different frames from among frames in which the cutting-in vehicle is detected,
calculate a travel distance of the cutting-in vehicle from a distance between the bounding boxes of the cutting-in vehicle in the selected two frames,
calculate a travel time of the cutting-in vehicle by applying a frame rate of the streaming images to a number of the frames in which the cutting-in vehicle is detected,
calculate a speed of the cutting-in vehicle based on the travel distance and the travel time, and
determine whether the cutting-in vehicle is speeding based on the calculated speed.

48. The apparatus of claim 47, wherein the speeding detector is configured to:
convert pixel coordinates of a center of a bounding box of each of the selected two frames into ground-truth coordinates using a homography, and
calculate the travel distance of the cutting-in vehicle from a distance of the ground-truth coordinates.

49. The apparatus of claim 48, wherein the speeding detector is configured to:
calculate the travel distance of the cutting-in vehicle according to Equation,
$$D = \sqrt{{( {x}_{2} - {x}_{1} )}^{2} - {( {y}_{2} - {y}_{1} )}^{2}}$$
where ‘D’ denotes the travel distance of the cutting-in vehicle, ‘x1’ and ‘y1’ are the ground-truth coordinates converted from the pixel coordinates of the center of the bounding box of the first frame among the selected frames, and ‘x2’ and ‘y2’ are the ground-truth coordinates converted from the pixel coordinates of the center of the bounding box of the second frame among the selected frames.

50. The apparatus of claim 45, further comprising:
a model generator configured to:
prepare learning data including an image and a label, the image containing a vehicle, and the label containing a ground-truth box indicating an area occupied by the vehicle in the image,
input the image into a detection model whose learning is uncompleted,
when the detection model detects a bounding box representing an area occupied by the vehicle in the image through a plurality of operations for applying untrained weights to the image,
calculate a loss representing a difference between the detected bounding box and the ground-truth box of the label, and
perform optimization by modifying the weights of the detection model so that the loss is minimized.
